(19) United States
(12) Patent Application Publication
(10) Pub. No.: US 2011/0098985 A1
(43) Pub. Date: Apr. 28, 2011

(54) System and method for managing information

(76) Inventor: Rob Lawson, West End Queensland (AU)

(21) Appl. No.: 12/801,033

(22) Filed: May 18, 2010

(30) Foreign Application Priority Data
Oct. 23, 2009 (AU) 2009905178

(51) Int. Cl. G06F 17/50

(52) U.S. Cl. 703/1

(57) ABSTRACT

A method of displaying one or more properties of a computerised model of an object is disclosed. The method comprises the steps of:
creating a template for mapping the one or more properties to one or more standard properties;
selecting an item or group of the model, wherein the item or group includes the one or more properties;
mapping the one or more properties of the selected item or group to the one or more standard properties in accordance with the template; and
displaying the standard properties.

### FIELD OF THE INVENTION

The present invention relates to a system and method for managing information, and particularly, although not exclusively, for managing design and construction information to suit requirements for various segments of industry.

Although the system and method according to embodiments of the present invention will be described with particular reference to managing information associated with a three-dimensional Autodesk® Navisworks® model, it will be appreciated that this is by way of example only and that the invention is not necessarily limited to managing such information.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Building information modelling (“BIM”) is the process of generating and managing building data during its life cycle. Typically, it uses three-dimensional, real-time, dynamic building modelling software to increase productivity in building design and construction. The process produces a building information model, which encompasses geometry, spatial relationships, geographic information, and quantities and properties of building components.

An example of building modelling software that is widely used in building information modelling is Autodesk® Navisworks® software. Navisworks® software applications combine design data created by other applications, such as those created by the AutoCAD and Revit® families of products, for example, with geometry and information from other design tools that can be reviewed in real-time as an entire three-dimensional project.

The Navisworks® software application is used to generate information in the form of a computerised 3D model of an object such as a construction project. The model comprises a plurality of items (which may also be referred to as elements or parts) or one or more groups of items. Each item or item group of the model has one or more attributes that are assigned to it by the Navisworks® software application, and a set of one or more properties describing the item or group. Each property has a property identifier, identifying the property for the item or group, and a corresponding property value, contained or stored in appropriate designated information or data fields.

Navisworks® is able to display in a data tab one or more of the properties of an item or group. Navisworks® has two basic kinds of data tabs that can be assigned to items or groups, one is read-only and the other is write-enabled. In the Navisworks® software application program, the only, way of assigning a writeable data tab to a particular item or group is to highlight the item or group, right-click in the properties tab, and manually create a tab. This can be time-consuming, particularly if many writeable data tabs need to be created.

Different parts of a Navisworks® model may each have a particular property, and the different parts may use a different identifier to identify the property. Such a situation can arise if the model comprises different models that have been created by different parties and that have been combined together using Navisworks®. If different parts of a model use different identifiers to identify a particular property, this can make it complicated and time-consuming for a user to search for the value of that property for the different parts. For example, if a first model that forms part of a Navisworks® model calls the mark property ‘Mark’, and another model that forms part of the same Navisworks® model calls it ‘Assembly’ or ‘Identification Mark’ etc., a person searching for the mark property value of the two models would need to know the property identifiers to search under and would have to look for those identifiers in order to find the property values.

It would therefore be desirable to simplify the way in which certain actions are able to be performed in relation to information that is associated with a Navisworks® model. For example, it would be desirable to simplify the actions a user needs to take in order to display one or more properties of such a model, and to be able to use the same property identifier to identify the same property for different parts of the model.

Navisworks® can include a plug-in application called Timeliner which is used for creating simulations in Navisworks®. Timeliner imports schedules from a variety of sources, and allows users to connect or associate objects in a Navisworks® model with tasks in the schedule, to simulate the schedule showing the effects on the model, including planned against actual schedules, and to export images and animations based on the results of the simulation.

Timeliner requires manual configuration in order to do many of the things that it is able to do. Also, it is unable to link to Excel, MDB or ODBC data sources.

It would therefore be desirable to provide a way of assigning scheduling data to Timeliner to reduce the amount of manual configuration that is required, and it would also be desirable to be able to link Timeliner to other data sources such as Excel, MDB or ODBC data sources.

Moreover, in general it would be desirable to provide a user interface for performing the aforementioned actions, as well as a way of modifying the user interface.

Each document, reference, patent application or patent cited in this text is expressly incorporated herein in their entirety by reference, which means that it should be read and considered by the reader as part of this text. That the document, reference, patent application, or patent cited in this text is not repeated in this text is merely for reasons of conciseness.

### DISCLOSURE OF THE INVENTION

The present invention seeks to overcome, or at least ameliorate, one or more of the deficiencies of the prior art mentioned above, or to provide the consumer with a useful or commercial choice.

Other advantages of the present invention will become apparent from the following description, taken in connection with the accompanying drawings, wherein, by way of illustration and example, a preferred embodiment of the present invention is disclosed.

According to a first broad aspect of the present invention, there is provided a method of displaying one or more properties of a computerised model of an object, the method comprising the steps of:
creating a template for mapping the one or more properties to one or more standard properties;
selecting an item or group of the model, wherein the item or group includes the one or more properties;
mapping the one or more properties of the selected item or group to the one or more standard properties in accordance with the template; and
displaying the standard properties.

Preferably, the computerised model is an Autodesk® Navisworks® model.

In a preferred form, the object is a building or other structure, or a plant such as a processing or manufacturing plant.

Preferably, the creating step comprises the steps of:
selecting a sample item or group of the model, wherein the sample item or group includes the one or more properties; and
collecting the one or more properties of the selected sample item or group.

Preferably, the creating step also comprises the step of selecting from the properties of the selected sample item or group.

Preferably, the creating step also comprises the step of entering a name for the one or more standard properties.

Preferably, the creating step also comprises the step of selecting an attribute from which the one or more properties are taken.

Preferably, the creating step also comprises the step of selecting an option to conduct a cyclic redundancy check (“CRC”) of the one or more properties.

According to a second broad aspect of the present invention, there is provided a computer-readable storage medium on which is stored instructions that, when executed by a computer, cause the computer to perform the method of operating a computer to display one or more properties of a computerised model of an object according to the first broad aspect of the present invention as hereinbefore described.

According to a third broad aspect of the present invention, there is provided a computer programmed to carry out the method of operating a computer to display one or more properties of a computerised model of an object according to the first broad aspect of the present invention as hereinbefore described.

According to a fourth broad aspect of the present invention, there is provided a method of managing information associated with a computerised model of an object, the method comprising the steps of:
selecting a command control; and
performing an action in relation to the information in response to selecting the command control.

Preferably, the computerised model is an Autodesk® Navisworks® model.

In a preferred form, the object is a building or other structure, or a plant such as a processing or manufacturing plant.

Preferably, the step of selecting the command control comprises clicking on the command control with a computer mouse.

The command control is preferably selected from a group comprising: an Info Bin command control; a Validate Data command control; an Append Data command control; a Create View Report command control; a Create Clash View Report command control; an Export Data command control; an Open File command control; a Colour Code command control; an Integrator Mapping command control; a DataLink command control; a Calculation command control; a Match Properties command control; and a Scheduling command control.

Preferably, the command control is a button.

In a preferred form, the method also comprises the step of expanding a menu that contains the command control. The step of expanding the menu preferably comprises the step of selecting a menu button bar of the menu.

Preferably, the method also comprises the steps of:
selecting a configuration control associated with the command control; and
configuring the command control.

It is preferred that the step of selecting the configuration control comprises clicking on the configuration control with a computer mouse.

The step of configuring the command control preferably comprises the step of completing a dialogue box.

Preferably, the step of configuring the command control also comprises the steps of:
selecting a sample; and
retrieving one or more properties of the selected sample.

The step of selecting a sample may comprise selecting a sample item or group from the computerised model, or it may comprise selecting sample scheduling data for the computerised model. Preferably, the sample item or group are selected by clicking on the computerised model with a computer mouse.

According to a fifth broad aspect of the present invention, there is provided a computer-readable storage medium on which is stored instructions that, when executed by a computer, cause the computer to perform the method of managing information associated with a computerised model of an object according to the fourth broad aspect of the present invention as hereinbefore described.

According to a sixth broad aspect of the present invention, there is provided a computer programmed to carry out the method of managing information associated with a computerised model of an object according to the fourth broad aspect of the present invention as hereinbefore described.

According to a seventh broad aspect of the present invention, there is provided a method of modifying a user interface of a system for managing information associated with a computerised model of an object, the method comprising the steps of:
selecting a configuration control of the user interface, wherein the configuration control is for configuring a command control of the user interface; and
configuring the command control.

Preferably, the computerised model is an Autodesk® Navisworks® model.

In a preferred form, the object is a building or other structure, or a plant such as a processing or manufacturing plant.

Preferably, the selecting step comprises clicking on the configuration control with a computer mouse.

The step of configuring the command control preferably comprises the step of completing a dialogue box.

Preferably, the step of configuring the command control also comprises the steps of:
selecting a sample; and
retrieving one or more properties of the selected sample.

The step of selecting a sample may comprise selecting a sample item or group from the computerised model, or it may comprise selecting sample scheduling data for the computerised model. Preferably, the sample item or group are selected by clicking on the computerised model with a computer mouse.

According to an eighth broad aspect of the present invention, there is provided a computer-readable storage medium on which is stored instructions that, when executed by a computer, cause the computer to perform the method of modifying a user interface of a system for managing information associated with a computerised model of an object according to the seventh broad aspect of the present invention as hereinbefore described.

According to a ninth broad aspect of the present invention, there is provided a computer programmed to carry out the method of modifying a user interface of a system for managing information associated with a computerised model of an object according to the seventh broad aspect of the present invention as hereinbefore described.

According to a tenth broad aspect of the present invention, there is provided a computer-readable storage medium on which is stored instructions that, when executed by a computer, cause the computer to display a user interface of a system for managing information associated with a computerised model of an object, the user interface comprising a command control, and a configuration control for configuring the command control.

Preferably, the computerised model is an Autodesk® Navisworks® model.

In a preferred form, the object is a building or other structure, or a plant such as a processing or manufacturing plant.

Preferably, the command control is a button.

Preferably, the configuration control is a button.

It is preferred that the user interface also comprises a command menu that includes the command control. The command menu preferably includes a menu button bar for expanding and collapsing the command menu.

It is preferred that the user interface also comprises a configuration menu that includes the configuration control. The configuration menu preferably includes a menu button bar for expanding and collapsing the configuration menu.

According to an eleventh broad aspect of the present invention, there is provided a computer programmed to display a user interface of a system for managing information associated with a computerised model of an object, the user interface comprising a command control, and a configuration control for configuring the command control according to the tenth broad aspect of the present invention as hereinbefore described.

Preferably, the computerised model is an Autodesk® Navisworks® model.

In a preferred form, the object is a building or other structure, or a plant such as a processing or manufacturing plant.

Preferably, the command control is a button.

Preferably, the configuration control is a button.

It is preferred that the user interface also comprises a command menu that includes the command control. The command menu preferably includes a menu button bar for expanding and collapsing the command menu.

It is preferred that the user interface also comprises a configuration menu that includes the configuration control. The configuration menu preferably includes a menu button bar for expanding and collapsing the configuration menu.

According to a twelfth broad aspect of the present invention, there is provided a method of assigning scheduling data to a computerised model of an object comprising one or more items or groups, the method comprising the steps of:
creating a template for loading the scheduling data from a scheduling data source;
loading the scheduling data from the scheduling data source in accordance with the template;
selecting the items or groups; and
assigning the selected items or groups and a task type to the loaded schedule data.

Preferably, the computerised model is an Autodesk® Navisworks® model.

In a preferred form, the object is a building or other structure, or a plant such as a processing or manufacturing plant.

Preferably, the scheduling data includes name, start date, end date, planned start date, planned end date, index and GUID data.

Preferably, the step of creating a template comprises completing a dialogue box.

Preferably, the scheduling data source is an Excel, MDB, ODBC or scheduling data source.

Preferably the loading step comprises loading the scheduling data from the scheduling data source into a panel of a Timeliner plug-in software application for an Autodesk® Navisworks® software application or solution.

Preferably, the assigning step comprises sending low-level messages directly into a tasks listbox of the Timeliner plug-in software application.

Preferably, the template is also for assigning workpacks to at least some of the items or groups using an intermediary mapping file, and the method also comprises the step of assigning workpacks to at least some of the items or groups in accordance with the intermediary mapping file. The intermediary mapping file is preferably an Excel file.

According to a thirteenth broad aspect of the present invention, there is provided a computer-readable storage medium on which is stored instructions that, when executed by a computer, cause the computer to perform the method of assigning scheduling data to a computerised model of an object comprising one or more items or groups according to the twelfth broad aspect of the present invention as hereinbefore described.

According to a fourteenth broad aspect of the present invention, there is provided a computer programmed to carry out the method of assigning scheduling data to a computerised model of an object comprising one or more items or groups according to the twelfth broad aspect of the present invention as hereinbefore described.

In accordance with a fifteenth broad aspect of the present invention, there is provided a system for managing information, the system comprising a computer and a storage means coupled thereto, wherein the system is operable to:
receive information comprising a model of a subject, wherein the model comprises a plurality of items, each item having a set of item attributes relating to properties of the item, and each item attribute having a first attribute identifier, identifying the attribute for the item, and a corresponding first attribute value;
store the information in the storage means; and
generate a representation of an item of the model on the basis of the information, wherein the item representation comprises a second attribute identifier associated with the first attribute identifier of the item and the corresponding first attribute value.

Preferably, the subject comprises a construction project.

Preferably, the system further comprises a human machine interface to facilitate operation of the system.

### BRIEF DESCRIPTION OF THE DRAWINGS

The invention will now be described, by way of example only, with reference to the accompanying drawings, of which:

FIG. 1 depicts a computer;

FIG. 2 depicts a processor and a storage device of the computer depicted in FIG. 1;

FIG. 3 depicts a tools menu of an Autodesk® Navisworks® software application that is run on the computer depicted in FIG. 1;

FIG. 4 depicts an application window of a plug-in software application for the Autodesk® Navisworks® computer software application;

FIG. 5 depicts an Enter Password dialogue box of the plug-in software application;

FIG. 6 depicts a Security dialogue box of the plug-in software application;

FIG. 7 depicts the application window of the plug-in software application following the addition of more command menus to the window;

FIG. 8 depicts the upper portion of the application window of the plug-in software application when the Calculations menu is collapsed;

FIG. 9 depicts the upper portion of the application window of the plug-in software application when the Calculations menu is expanded;

FIG. 10 depicts the General Configuration dialogue box of the plug-in software application;

FIG. 11 depicts the Standard Tools/Misc menu in the application window of the plug-in software application;

FIG. 12 depicts a Validate Data dialogue box;

FIG. 13 depicts a Done message box of the plug-in software application;

FIG. 14 depicts another Done message box of the plug-in software application;

FIG. 15 depicts an Add Property dialogue box of the plug-in software application;

FIG. 16 depicts an expanded version of the Add Property dialogue box depicted in FIG. 15;

FIG. 17 depicts a Select Views to Include dialogue box of the plug-in software application;

FIG. 18 depicts another Select Views to Include dialogue box of the plug-in software application;

FIG. 19 depicts an Export Configuration dialogue box of the plug-in software application;

FIG. 20 depicts an MDB Setup Dialogue dialogue box of the plug-in software application;

FIG. 21 depicts the Fields to Add to Export Tree of the Export Configuration dialogue box depicted in FIG. 19 after the Tree has been expanded;

FIG. 22 depicts an expanded Export Data menu of the application window of the plug-in software application;

FIG. 23 depicts a Report View window of the plug-in software application;

FIG. 24 depicts an expanded Open File menu of the application window of the plug-in software application;

FIG. 25 depicts a File Definition Configuration dialogue box of the plug-in software application;

FIG. 26 depicts a Colour Code Setup dialogue box of the plug-in software application;

FIG. 27 depicts an expanded Colour Code menu of the application window of the plug-in software application;

FIG. 28 depicts a Selection Sets window of the plug-in software application;

FIG. 29 depicts a colour-coded three-dimensional model displayed in the Autodesk® Navisworks® application window;

FIG. 30 depicts an Integrator Configuration dialogue box of the plug-in software application;

FIG. 31 depicts an expanded Integrator Mappings menu of the application window of the plug-in software application;

FIG. 32 depicts a Done message box of the plug-in software application;

FIG. 33 depicts a Data Link Configuration dialogue box of the plug-in software application;

FIG. 34 depicts a grid of the Data Link Configuration dialogue box depicted in FIG. 33 when the grid also includes an NW Internal Name column;

FIG. 35 depicts an expanded Data Links menu of the application window of the plug-in software application;

FIG. 36 depicts a Done message box of the plug-in software application;

FIG. 37 depicts a Calculations dialogue box of the plug-in software application;

FIG. 38 depicts an expanded Calculations menu of the application window of the plug-in software application;

FIG. 39 depicts a message box that is displayed by the plug-in software application after the Calculations command in the Calculations menu is executed;

FIG. 40 depicts a message box that is displayed by the plug-in software application after the Calculations command in the Calculations menu is executed and the command is unable to find the values on all of the selected items in the model;

FIG. 41 depicts a Match Properties Configuration dialogue box of the plug-in software application;

FIG. 42 depicts an expanded Match Properties menu of the application window of the plug-in software application;

FIG. 43 depicts a Schedule Configuration dialogue box of the plug-in software application;

FIG. 44 depicts the Schedule Configuration dialogue box when it also includes Model Link fields;

FIG. 45 depicts sample scheduling data for configuring a Scheduling Command of the plug-in software application;

FIG. 46 depicts mapping data for configuring a Scheduling Command of the plug-in software application;

FIG. 47 depicts the application window of the plug-in software application when the Scheduling menu is expanded;

FIG. 48 depicts a Links tabbed box of the Navisworks® Timeliner panel after a Scheduling Command in the Scheduling menu has linked scheduling data to Timeliner; and

FIG. 49 depicts a Tasks tabbed listbox of the Navisworks® Timeliner panel after the scheduling data has been loaded into Timeliner.

### BEST MODE(S) FOR CARRYING OUT THE INVENTION

An embodiment of an information management system will now be described in detail with reference to the drawings. The system is used for managing design and construction information to perform activities that are required to be done in the construction industry. In particular, it is used in building information modelling (“BIM”)—the creation and use of coordinated and computable information about a construction project during and beyond the design and build phase.

It should be appreciated that the system is not limited to such activities, however, and alternative embodiments of the system can be used to manage information relating to any activity or subject in any environment, including, for example, molecular data models, 3D medical scans, topographic models, virtual shopfronts, and GPS-assisted tracking systems (i.e. shipping containers).

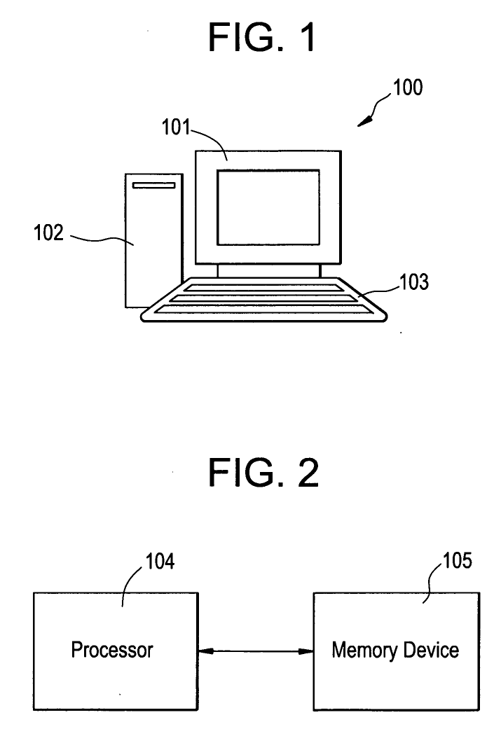

The system comprises a management tool in the form of a managing computer software application (“application”) stored and run on a computer 100 depicted in FIG. 1. The application can be written in any suitable language, and in the described embodiment is developed in C# as is well-known to persons skilled in the art. The application can be provided as a standalone application or via a network, depending on the system requirements.

In the embodiment described, the application (called “iConstruct”) is a plug-in application to an Autodesk® Navisworks® software application or solution. Autodesk® Navisworks® software applications combine design data created by other applications, such as those created by the AutoCAD and Revit® families of products, for example, with geometry and information from other design tools that can be reviewed in real-time as an entire three-dimensional (“3D”) project. The use, operation and functionality of Autodesk® Navisworks® software applications are well known to persons skilled in the art and need not be described in any further detail herein except as is relevant to the present invention.

The Autodesk® Navisworks® software application is used to generate information in the form of a computerised 3D model of an object, the object being a construction project in the embodiment described. The model comprises a plurality of items (which may also be referred to as elements or parts) or one or more groups of items. Each item or item group of the model has one or more attributes that are assigned to it by the Navisworks® software application, and a set of one or more properties describing the item or group. Each property has a property identifier, identifying the property for the item or group, and a corresponding property value, contained or stored in appropriate designated information or data fields.

The invention is not limited to use with Autodesk® Navisworks® software, however, and in alternative embodiments may be used with other software applications, or be operable to generate a model of an object itself.

The computer 100 can be of any suitable type, such as a personal desktop or notebook computer, for example.

The computer 100 includes display means in the form of a monitor or visual display 101, a container such as a box 102 for housing various components of the computer 100 such as the motherboard, processor, disk drives and power supply of the computer 100, and control means such as a keyboard 103 and other suitable peripheral devices such as a mouse (not depicted). Together, the display 101, keyboard 103 and other peripheral devices provide a Human or Man Machine Interface (“HMI”) to enable a user to interact with the application.

Referring to FIG. 2, the computer 100 also includes processing means such as a central processor 104 and storage means such as a memory device 105 for the storage and running of an operating system such as Windows®, and one or more software applications, including the application of the embodiment of the present invention. The use and operation of computers using software applications is well known to persons skilled in the art and need not be described in any further detail herein except as is relevant to the present invention.

The user, being a worker in the industry in the embodiment described, of the application, inputs data for interaction with and processing by the application via a graphical user interface (“GUI”) which is part of the HMI and which is displayed on the display 101. The HMI presents a graphical display to the user through which the user inputs and reads data therefrom.

As described above, alternative embodiments of the invention can be used to manage information pertaining to any activity. Accordingly, in alternative embodiments of the invention the user or operator could be anyone required or wishing to perform actions in respect of the information relevant to the embodiment.

The use of graphical user interfaces and the inputting and reading of data therefrom is well known to persons skilled in the art and need not be described in any further detail herein except as is relevant to the present invention.

Data or information received by the computer 100, for example inputted by the user via the HMI, generated by the Autodesk® Navisworks® application (such as the model), or uploaded from another source, for example, may be stored in a database coupled to the computer 100 and in data communication therewith in order to enable data to be read to and from the database, as is well known to persons skilled in the art. In the embodiment described herein, the database is a choice between an Excel spreadsheet, Access database, or the ODBC (Open Database Connectivity) driver may be utilized to connect to a compliant database i.e. SQL Server, Oracle, etc., although any suitable database structure can be used. Also, templates may be stored in a registry as either ‘serialized’ C# objects or as clear text if relevant—this negates the requirement for additional database software to be installed. The registry entries can then be saved to a file for importation into another computer. The database can be provided locally as a component of the computer 100 (such as in the storage means) or remotely such as on a remote server. In this embodiment, several computers can be set up this way to have a network client-server application. There is at least one database of information for the application in the embodiment described and it is stored in the storage means of the computer 100. In alternative embodiments there may be more than one database of information.

The application is operable to enable the user to perform a number of actions in respect of the information generated by the Autodesk® Navisworks® application—the model of the object. The performing of the actions is facilitated by the use of a set of default tools provided in the application and a set of customised tools created by the user within the application.

Particularly, the application presents to the user via the HMI the means to perform functions or operations in relation to the model, including:
Datalink functionality—import project information from data sources such as Microsoft® Excel® spreadsheet files, Microsoft® Access® database files, or any other Open Database Connectivity (ODBC) data source, and display the imported project information in manageable model property tabs;
Colour code reporting—colour code models against database or Microsoft® Excel® spreadsheets with the ability to group elements and have this information embedded into properties of the model;
Customisable reports—create presentable report templates with company trade marks, etc, selected information fields and multiple formats (e.g. Microsoft® Excel® spreadsheet, Microsoft® Access® database and Portable Document Format (PDF)). This allows tailoring to suit stakeholder requirements;
Automated file linking—automatically append various files to a model by linking file names to model properties, advantageously allowing rapid recovery of relevant information;
Calculations—create custom calculations with various formulae to allow the user to query models and element properties, and to save the calculations to industry or project specific templates;
Standardised display—controlling all data into a user defined template. Thereby advantageously reducing confusion and creating standardisation company and project wide;
Information bins—allocate folders to tasks of parts within a model so additional reports, install procedures and all other relevant construction information can be marked against the model;
Cyclic Redundancy Check (“CRC”) Validation—perform CRCs to determine if data within user created property tabs have been modified, and display items that fail this validation; and
Batch append—attach custom data to a user selection within the model. Custom settings allow the user to group selected items by the appended data into any required format, such as workpacks.

The above and other features and advantages of the embodiment of the invention will now be further described with reference to the system in use.

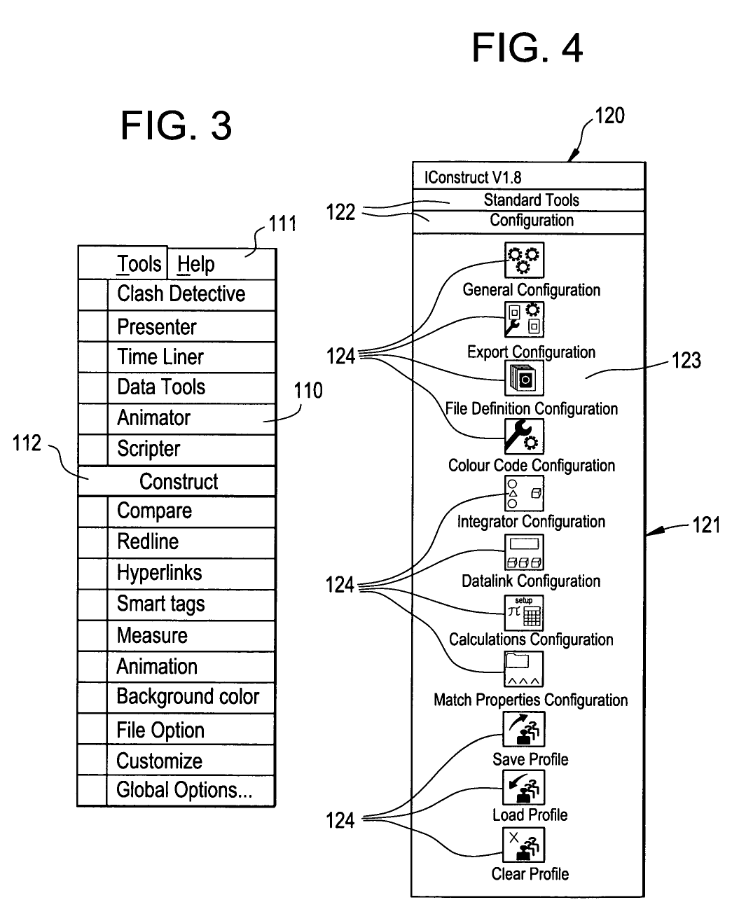

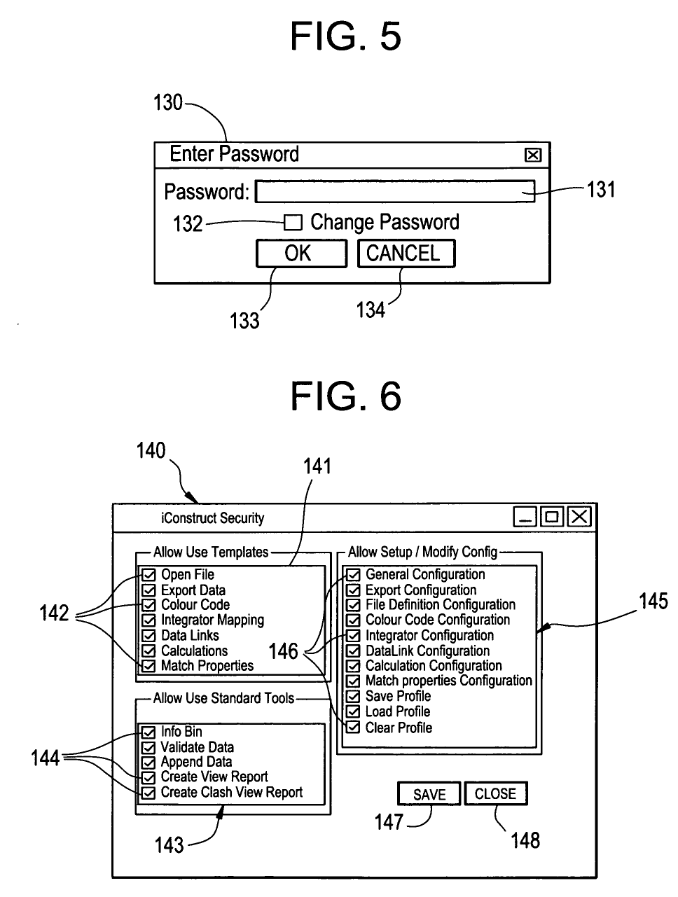

Referring to FIG. 3, the plug-in application is opened from within the Autodesk® Navisworks® application by selecting a tools menu 110 that is located on a menu bar 111 of the Navisworks® application, and then selecting a menu item 112 for the application from the tools menu 110. The menu item 112 is entitled “iConstruct” in the particular embodiment of the application described herein.

As illustrated in FIG. 4 of the drawings, in the embodiment described, upon execution the application is operable to generate and present to the user via the HMI an application window 120 on the display 101 within the Autodesk® Navisworks® application. Via the HMI, the user is able to move the application window 120 from a first or docked position where it is docked and hidden in a manner similar to other Autodesk® Navisworks® tools, to a second or floating position depicted in FIG. 4 where it is moveable about the display 101. When first executed, the application window 120 opens in the docked position. However, it is advantageous to use the application window 120 in the floating position where it can be moved around a main workspace on the display 101 or onto a user's dual screen. Such a floating application window 120 enables the user to fully utilise control means in the form of an intuitive button bar control accessible via the application window 120, as will be described in further detail below.

Presentation of the intuitive button control in this way is beneficial as users having prior experience with Autodesk® Navisworks® applications find it easier to become familiar with the button bar control of the application whilst they are using it with other Autodesk® Navisworks® tools.

If the application window 120 is closed, it can be re-opened through the tools menu 110 in the same manner as described previously. When the window 120 is closed, it will assume its last displayed position and size next time the application is launched.

In the embodiment described, the functionality provided by the application is organised into the following areas:
1) Menus; and
2) Tool-setting/configuration and command buttons.

### Menus

As described previously, the application is operable to provide the user, via the HMI, with tools to perform specific actions in respect of the information, and to create additional tools.

Each tool is associated with a particular menu 121. Each menu includes a button bar 122, a panel 123, and one or more buttons 124 arranged on the panel 123. The buttons 124 include tool setting or command buttons. The menus 121 are operable to organise the buttons 124 for the different tool settings and commands to allow for easier location and identification by the user. To access a particular tool setting or command button 124, the user selects the button bar 122 that has the relevant menu title associated with the particular tool setting or command button 124.

By default, at the beginning of setup for a particular project/profile, the application begins with only two menus 121, entitled ‘Configuration’ and ‘Standard Tools’. Once additional tools have been configured and command buttons 124 established for them by the user, the application is operable to generate and display via the HMI a new menu 121 for these relevant tools in which they are grouped according to their associated functionality, as will be described in further detail below.

### Tool Settings and Commands

As described above, under each menu there is a set of associated tool settings or command buttons 124. The tool setting buttons 124 allow the user to configure the settings of specific tool command buttons 124 to produce certain output and reports. All the tool setting buttons 124 are located under the Configuration menu 121.

The tool command buttons 124 are listed under their respective menus 121. When pressed, the command buttons 124 perform functions that have been set up through the tool's configuration button 124. The command buttons 124 that are listed are the results of templates created and saved under the Configuration menu 121. The user may remove command buttons 124 from the associated command menu 121 by deleting the template using the setting buttons 124 in the Configuration menu 121.

### Setting Security

The toolsets and configuration menus that are available to users can be customised and saved to a user's profile in the storage means using the application's security option. This enables management to control and monitor which toolsets are available to the users.

To begin the customisation of a selected profile, an approved user/administrator uses a mouse of the HMI to right-click on the application window 120 to display a pop-up menu (not depicted), and to select a “Set Security” menu item from the pop-up menu. After selecting the “Set Security” menu item, the user/administrator is prompted with an Enter Password dialogue box 130 to protect any subsequent customisation that is made. The dialogue box 130 includes a Password textbox 131 into which the password is typed or otherwise entered, a Change Password checkbox 132, an OK button 133 for entering the password that has been typed into the textbox 131, a CANCEL button 134 for cancelling the customisation. If the password needs to be changed, the checkbox 132 needs to be ticked by left-clicking on it with the mouse. Once the checkbox 132 is ticked, the user/administrator is prompted to enter their old password before the new password they have entered into the textbox 131 is accepted.

After a correct password has been entered into the password checkbox 131 and the OK button 133 of the dialogue box 130 has been left-clicked on with the mouse, a Security dialogue box 140 is displayed. The user/administrator is then able to select which tools and configuration settings are made available to users of that profile. Dialogue box 140 includes an Allow Use Templates menu 141 containing a plurality of checkboxes 142 for enabling/disabling access to the different templates. Dialogue box 140 also includes an Allow Use Standard Tools menu 143 containing a plurality of checkboxes 144 for enabling/disabling access to the different standard tools. In addition, the dialogue box 140 includes an Allow Setup/Modify Config menu 145 containing a plurality of checkboxes 146 for enabling/disabling setup/modification of the various items on the Configuration menu 121. There is also a SAVE button 147 for saving the selections made in the box 130, and a CLOSE button 148 for closing the box 140 without saving any changes that have been made thereto. Amendments to the selections made in the box 140 can be made at any time by entering the established password when prompted, making the necessary changes and selecting the SAVE button 147 then the CLOSE button 148.

### Configuration Menu

The Configuration menu 121 is operable to enable the user to generate and establish the functionality of advanced tool menus 121 and their command buttons 124, and to access profile management options of the application. If the administrator does not want a user to alter specific settings, it is advisable for the administrator to hide them using the Allow Setup/Modify Config menu 145 in the Security dialogue box 140. All amendments and configurations that are made are stored/saved within the opened profile.

FIG. 4 of the drawings illustrates the options available via the Configuration menu 121. The options are each associated with a respective button 124 and are as follows:

General Configuration: Allows the user to set default properties/other configurable items for the application.

Export Configuration: Allows the user to define export templates for exporting data to mdb/accdb, xls/xlsx or pdf reports.

File Definition Configuration: Allows the user to link properties with existing documents/pdfs.

Colour Code Configuration: Allows the user to set up the configuration for running colour codes against excel spreadsheets, access databases or odbc data sources. Optionally allows for stamping of colour code data into a model if a writeable data tab is selected.

Integrator Configuration: Allows the user to define data from various property tabs that will be brought into a company or project defined property tab.

DataLink Configuration: Allows the user to set up external data sources to be appended to a writable data tab inside of Autodesk® Navisworks®.

Calculation Configuration: Allows the user to define calculations to perform on selected items.

Save Profile: Allows the user to save all application settings to a profile in the storage means of the computer 100.

Load Profile: Allows the user to load settings from an existing profile.

Clear Profile: Allows the user to reset the application to default conditions.

### Tool Command Menu

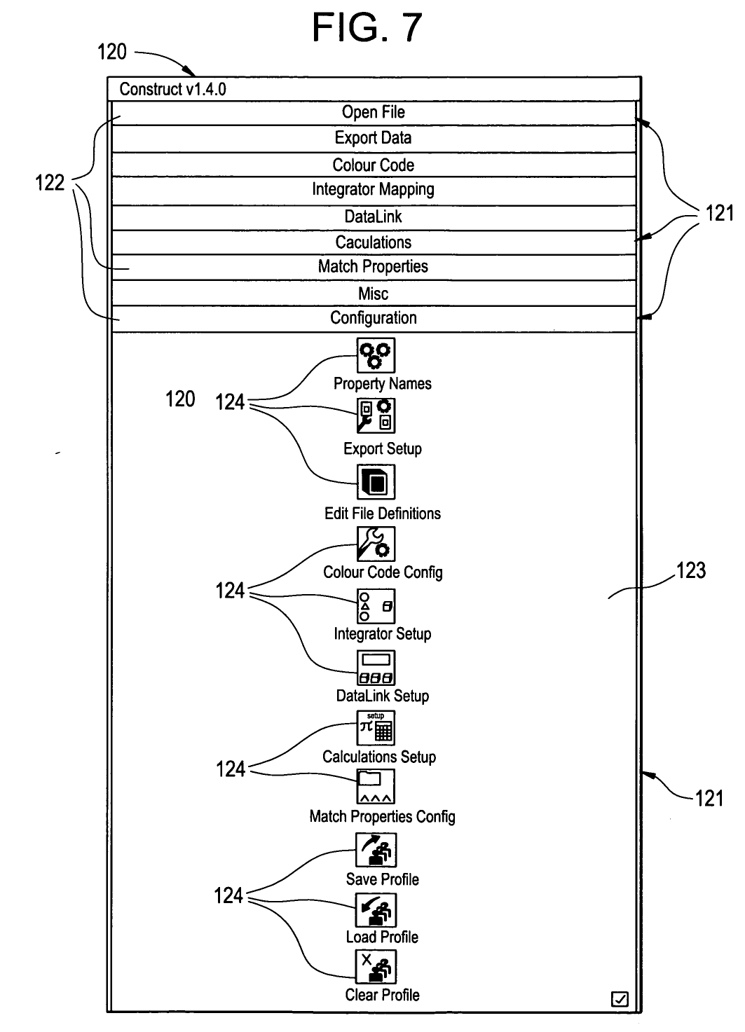

FIG. 7 depicts the application window 120 after a plurality of tool command menus 121 and their associated tool command buttons 124 (not depicted) have been added to the application window 120. Each new tool command menu 121 has an associated menu button bar 121.

Once a configuration template has been saved it will end up on a menu as a tool command button 124. Such tool command buttons 124 can be removed from a command menu 121 by deleting the original template for the tool command button 124 using the appropriate tool setting button 124 on the Configuration menu 121.

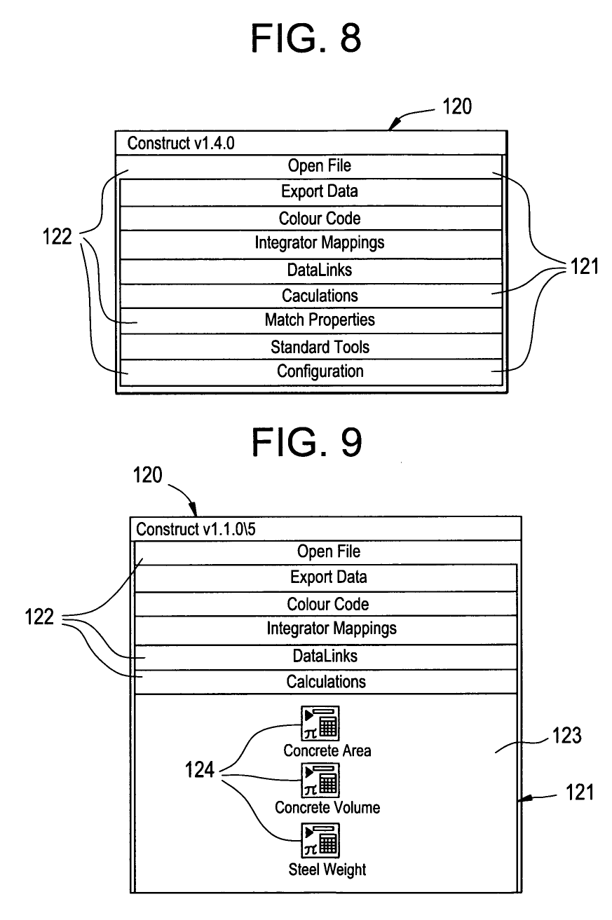

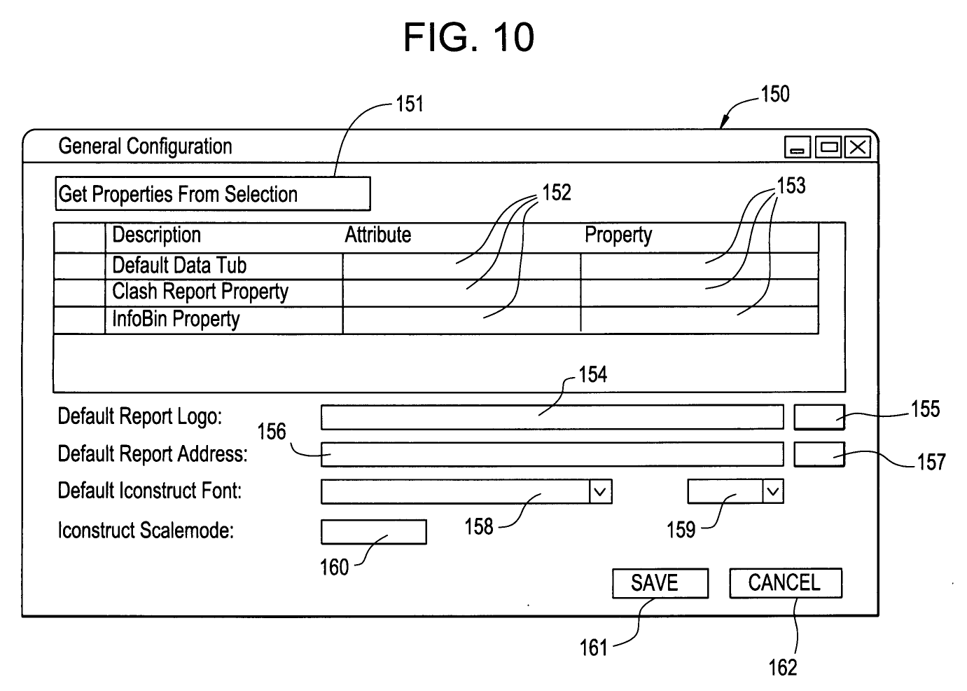

All command menus 121 are hidden until they are selected by clicking on their button bar 122. Then they will expand providing access to all of the tool command buttons 124 for the command menu 121 associated with the clicked button bar 122. For example, after left-clicking on the button bar 122 for the Calculations menu as shown in FIG. 8, the Calculations menu 121 will expand as shown in FIG. 9 so that the tool command buttons 124 that are associated with that menu 121 are displayed.

### Profile Management

A profile stores all the settings and configuration that has been done on all the toolsets and templates inside of the application, which can then be passed on to other users without having to replicate the same configuration work. This advantageously allows management/consultants to establish customised profiles to suit organisational, team or project standards.

There are three options available for profile management. Each option is associated with a respective button 124 in the Configuration menu. In particular, the profile management options are associated with the Save Profile, Load Profile and Clear Profile buttons 124 on the Configuration menu 121. The functionality of each of those buttons will now be described.

Save Profile: Selecting this button 124 opens a Save As dialogue box allowing the user to create a new profile or override/update an existing profile. All configurations and amendments made are saved or updated to the new or existing profile. Security passwords that are active at the time are saved to the profile.

Load Profile: Selecting this button 124 allows a user to open previously saved profiles and import all the settings and configurations that are associated with that profile. When a new profile is loaded any existing profiles that are open will close.

Clear Profile: Selecting this button 124 will close the current profile and restore the application to its default state. The Clear Profile button 124 should be selected when a user wants to create a new user profile from the start to avoid editing or overriding existing profiles.

### General Configuration

Selecting the General Configuration button 124 in the Configuration menu 121 depicted in FIG. 4 causes a General Configuration dialogue box 150 to be displayed. The General Configuration dialogue box 150 has a range of default settings that interact with a range of the multiple toolsets and some of the default display settings.

After opening the General Configuration dialogue box 150, a sample of objects that are part of the object model that is open in the Autodesk® Navisworks® application and that have the desired data/property names are selected. Selecting the entire model gives access to all available data tabs and properties, but takes a lot longer than picking a few ‘typical’ items. Once a few items (or the entire model if desired) have been selected, a Get Properties From Selection button 151 in the dialogue box 150 is pressed.

This will then provide some general configuration options, which requires an attribute and property to each option. These options include:

Default Data Tab: The default data tab to write data to when running commands through the application, unless a new data tab has been specified otherwise. The default data tab must be a writable tab (i.e. an added new user's data tab inside of Autodesk® Navisworks®).

Clash Report Property: The custom property the user wishes to have for each element in the application's view report. This information could be internal data of the object or any external data that has been brought into the model through a DataLink tool command. This is related to a Create Clash View Report tool command in the Standard Tools/Misc menu 121.

Info Bin Property: The property to use as the name for Info Bin folders that are created using an Info Bin tool command in the Standard Tools/Misc menu 121, and the property field that the folders will be tagged to. Any time an item is selected it will search for the Info Bin (if created) associated to this defined property. If no Info Bin exists, the application prompts the user to create one:

The attributes and properties for the Default Data Tab, Clash Report Property and Info Bin Property are selected from listboxes 152, 153.

The other general configuration options, that are not associated with the model's attributes and properties, are the report settings. This includes;

Default Report Logo: Allows a user to import or select a company or project logo to display on the application's report output as a default unless specified on other templates. The location of the logo on the storage means of the computer 100 is entered as a path. This can be done manually by typing the path into a textbox 154, or by browsing for the logo after pressing a button 155.

Default Report Address: Allows a user to enter a company address or custom text field to be displayed at the header of the application's report output as a default unless specified on other templates. The location of the address on the storage means of the computer 100 is entered as a path. This can be done manually by typing the path into a textbox 156, or by browsing for the address after pressing a button 157.

Default iconstruct font and size: Allows a user to choose the default font and size to be used in the application's interface and dialogue boxes. The default font is selected from a listbox 158, and the default font size is selected from a listbox 159.

Iconstruct Scalemode: Determines whether the dialogue boxes and the text displayed are rescaled depending on the resolution settings. This option should be used if the users are having issues with the visibility of the dialogue boxes. The scalemode is selected from a listbox 160. By default this setting should be set to ‘font’, and only set to ‘off’ if the user is having issues viewing the interface.

Dialogue box 150 includes a SAVE button 161 for saving any changes that have been made, and a CANCEL button 162 for exiting the box 150 without saving any changes.

### Standard Tools/Misc Menu

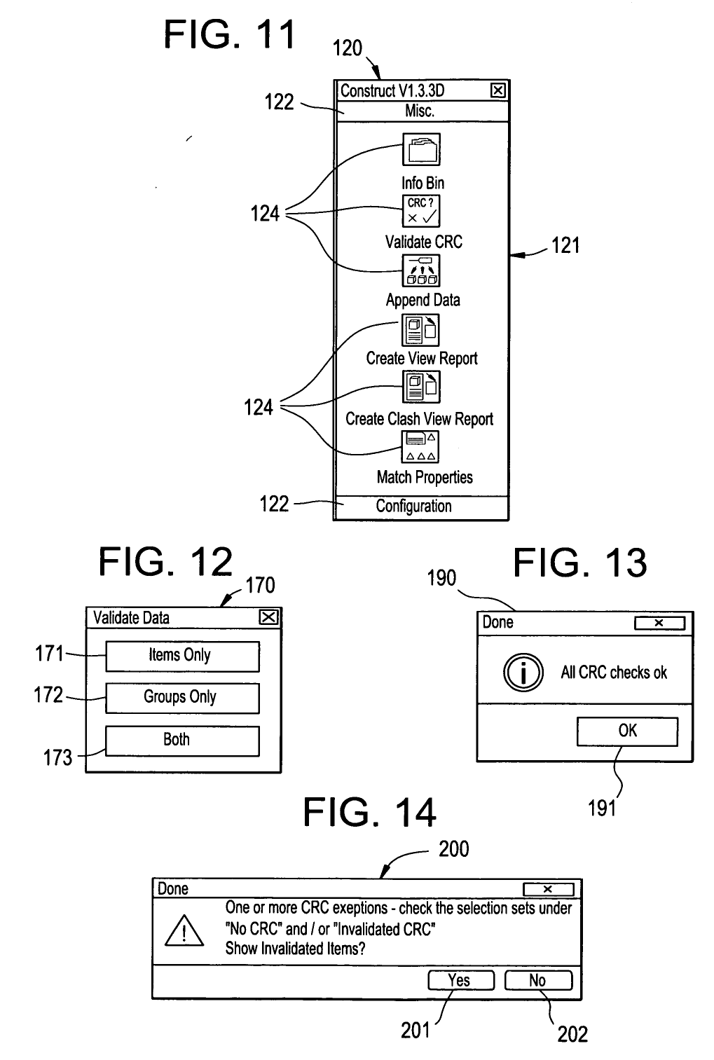

Referring to FIG. 11, the Standard Tools/Misc menu 121 contains a range of standard tool command buttons 124 that are either configured through the General Configuration button 124 or that don't require any configuration at all. The range of standard tool commands located under the Standard Tools menu 121 include:
Info Bin
Validate Data
Append Data
Create View Report
Create Clash View Report (only valid for Autodesk® Navisworks® Manage)

These tools will always remain under the Standard Tools menu 121 whether they require initial configuration or not.

### Info Bin Command

The Info Bin tool command links Navisworks® model objects (see General Configuration) with a folder located in the model's directory. If the directory does not exist, the user is prompted with the option to create one.

To perform this function, a user selects the item of the model where they would like to create or view its associated Info Bin, and then selects the Info Bin button 124 from the Standard Tools/Misc menu 121.

The Info Bin command can be used as a way of grouping and managing associated data so it can be retrieved quickly when needed by construction professionals.

### Validate CRC Command

The Validate CRC tool command performs a CRC (cyclic redundancy check) on properties within a model that have been nominated for CRC (see Integrator Configuration) in order to check if the values have been modified since an Integrator tool command was run.

To run a CRC, the objects in the model that are to be checked are first selected, then the Validate CRC button 124 is clicked. A Validate Data dialogue box 170 (see FIG. 12) will then appear. Dialogue box 170 includes an Items Only button 171, a Groups Only button 172, and a Both button 173. If the CRC should be on items only, the user clicks the Items Only button 171. If it is only on the Group, the user selects the Groups Only button 172. If it should be conducted on both, the user selects the Both button 173.

If the CRC check completes successfully with no invalidated data, a Done message box 190 depicted in FIG. 13 will appear. Message box 190 includes an OK button 191 that, when clicked, causes the box 190 to close.

If any of the items fail the CRC, a Done message box 200 depicted in FIG. 14 is displayed. Box 200 gives the user the option to view the items that failed. A Yes button 201 on the box 200 needs to be clicked to view the items that failed. Clicking a No button 202 on the box 200 closes the box 200.

### Append Data Command

The Append Data tool command is used to add custom data to a selection within the model, to the writeable tab defined (see General Configuration). This command can be useful for grouping items together or adding custom data on the fly.

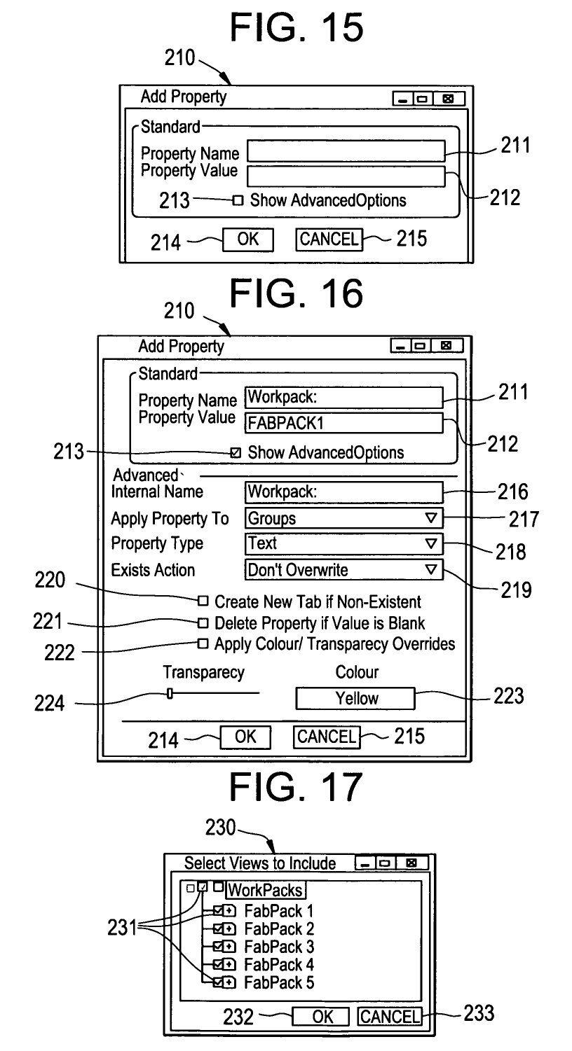

To perform the Append Data tool command, the user first highlights the items that are to have the data applied, and then clicks the Append Data button 124. An Add Property dialogue box 210 (see FIG. 15) will be displayed in its default form. Box 210 includes a Property Name textbox 211, a Property Value textbox 212, a Show Advanced Options checkbox 213, an OK button 214, and a CANCEL button 215.

To add a property, the user enters the name of the property into the textbox 211, and the value of the property into the textbox 212.

The user then selects checkbox 213 to expand the contents of the dialogue box 210 as shown in FIG. 16, and get access to a full list of what can also be appended with the data. The expanded dialogue box 210 provides the following options:

An Internal Name textbox 216 for entering the internal name that will be used for the property.

An Apply Property To listbox 217 for selecting whether the property value will be applied to items, groups or both.

A Property Type listbox 218 for selecting the data type that will be displayed within the property. This can be set to Text, Whole Number, Decimal Number or DateTime.

An Exists Action listbox 219 for selecting whether existing values are not overwritten, always overwritten, or the user is prompted (which provides the option to roll-back the changes already made).

A Create New Tab if Non-Existent checkbox 220. Checking box 229 will create a new tab to append the data to if it does not exist on certain groups and or items. This may exist when working from a collaborated model with multiple consultants models (from multiple sources).

A Delete Property if Value is Blank checkbox 221. Checking box 221 will remove the property field from selected items if the value is still blank. This may be used if the property was established initially, with values entered at a later date and the property field is not needed for blank values.

An Apply Colour/Transparency Overrides checkbox 222. Checking box 222 will apply a selected colour and level of transparency to selected items. This might be useful for grouping. The colour is selected by clicking on a Colour button 223. The transparency is selected by adjusting a slide control 224.

### Create View Report Command

The Create View Report tool command allows a user to produce a report from the saved viewpoints associated to the Navisworks® model, along with any attached comment information created in Navisworks®, and a space for written remarks. The View Report will also use the default logo and address (see General Configuration).

To run the command, the Create View Report button 124 is selected. This causes a Select Views to Include dialogue box 230 (see FIG. 17) to appear. Box 230 includes a plurality of checkboxes 231 for selecting the views that are required for the report. It also includes an OK button 232 and a CANCEL button 233. The OK button 232 is clicked to save the selected views and close box 230, and to display the report in the sample viewer, where it can be saved out as a PDF or Excel file. The CANCEL button 233 is clicked to close the box 230 without saving any changes to the selected views.

### Create Clash View Report Command

The Create Clash View Report tool command allows a report of selected clash views to be created, along with a nominated property (see General Configuration) for both the clashing items. The Clashes will also be grouped under their associated batch. The report can be run on a model that has clash results confirmed, even if clash detective functionality is not available on the machine (but the model has been saved after the tests have ran). Clash detection is required to run the test but Clash View Reports can be generated from any version of Navisworks®.

This tool command will use the clash saved in clash detective, so it is advisable to go through the clashes first to get the viewpoints looking correct. The command will also grey out all the items except for the 2 clashing items which will be highlighted yellow. This does not work if the model has had presenter materials applied to it though, as these cannot be overridden.

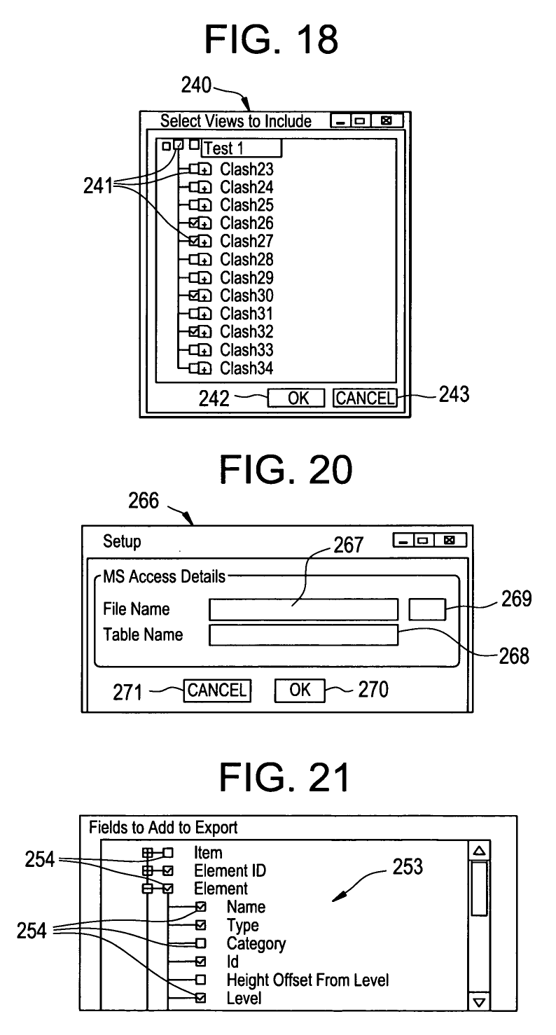

To produce a clash view report, the user selects the Create Clash View Report button 124. This will display a Select Views to Include dialogue box 240 (see FIG. 18). Box 240 includes a plurality of checkboxes 241 for selecting the views that are required for the report. It also includes an OK button 242 and a CANCEL button 243. Once the required views have been selected, the OK button 242 is clicked to save the selected views, close the box 240 and display the report in the sample viewer, where it can be saved out as a PDF or Excel file. The Clash Report will also use the default logo and address (see General Configuration). Selecting the CANCEL button 243 causes the box 240 to close without saving the selected views.

### Export Configuration

Selecting the Export Configuration button 124 in the Configuration menu 121 (see FIG. 4) allows a user to preset and determine the report types that the user wishes to have produced and the content to be included based on selected elements within the Autodesk® Navisworks® model. Once a template has been saved, an export tool command button 124 is added to its associated menu 121 in the application window 120. After this has been added to the menu 121, the user can produce on the fly reports from selected items within the model by running the appropriate export data tool command.

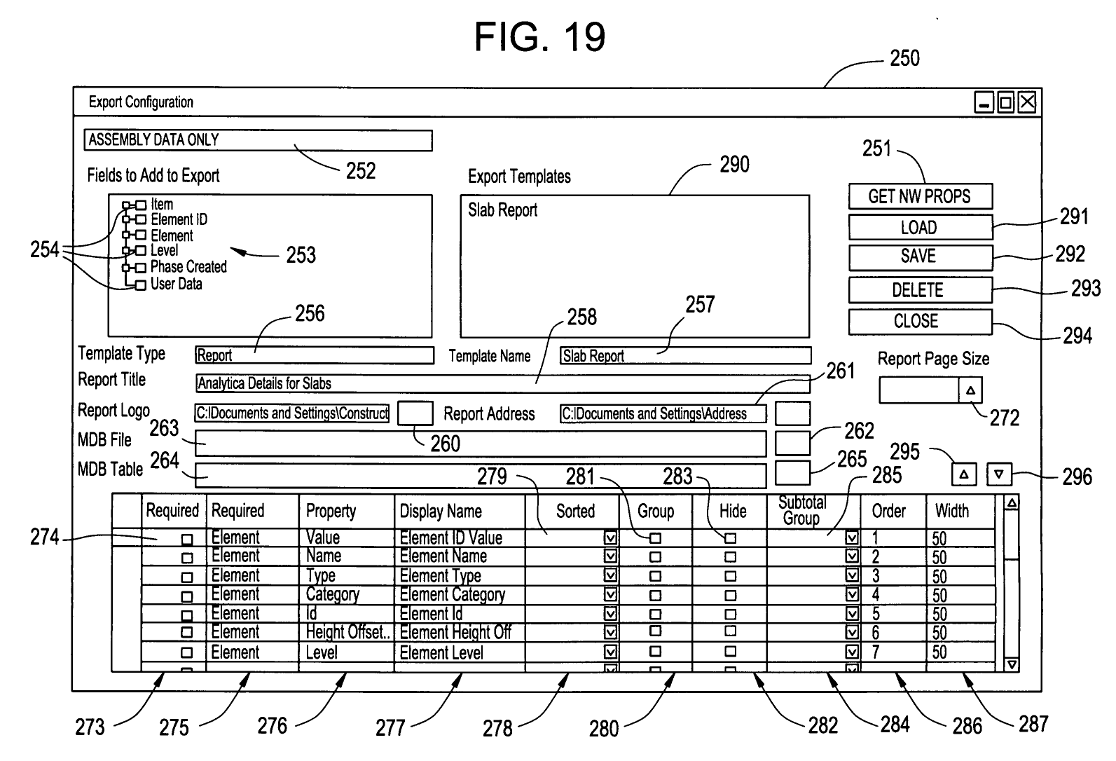

To begin configuring an export template, the user firstly needs to choose sample data from the model so as to draw the property fields that will be included in the report. Once the user is satisfied with the sample, they then need to select the Export Configuration button 124 in the Configuration menu 121 so as to display an Export Configuration dialogue box 250 (see FIG. 19). Box 250 includes a GET NW PROPS button 251 which needs to be selected to retrieve the properties of the selected sample of the Navisworks® model.

When the sample is being selected, attention needs to be paid to the selection resolution being used, e.g. if the user picks a sample item and it is the sub-part of a group, the group data property names will not appear.

Once the data has been retrieved/refreshed, the user needs to select whether group and/or item data is to be included in the reports. To do this, the user needs to click on a listbox/drop down menu 252, and select ‘Group Data’, ‘Item’ or ‘Link Group with Item’, depending on whether the user wants Group information, Item information or a report showing items that make up a group. Once this has been selected a Fields to Add to Export tree 253 will populate. Tree 253 includes a plurality of checkboxes 254. Selecting the checkboxes 254 of the properties that are to be exported will cause them to appear in a content grid 255 at the bottom of the dialogue box 250.

The user then selects which report file type they wish to use for the export template from a Template Type listbox 256 that provides four options: Report, Microsoft Excel, Microsoft Access, and Clipboard, which are outlined in more detail below. The columns within the content grid 255 will adjust depending on the reporting type selected from the listbox 256.

After selecting the report file type, the user can then begin to customise the report and its output. In this regard, box 250 includes the following options that can be edited:

Template Name textbox 257 for entering the name that the template will be saved under, and the title of the tool command button 124 that will appear under its associated menu 121.

Report Title textbox 258 for entering the output header that will appear on the report as the description and/or title of the report.

Report Logo textbox 259 for entering the location on the computer 100 of the logo that will be presented on the report output. The location is entered in the form of a path. This can be entered into the textbox 259 manually, or by pressing an associated button 260 to enable the user to browse for the logo. If the location of the report logo is not defined in the textbox 259, the default logo assigned within General Configuration is used.

Report Address textbox 261 for entering an address on the computer 100 for the report. The address is displayed on the header of the report output. The user needs to load a text file (.txt) containing the address as a paragraph for this to be displayed. The text file can be loaded using a button 262.

The Report Title, Report Logo and Report Address will only be displayed on report and .xls report types.

MDB File textbox 263 and MDB Table textbox 264. The .mdb file (if .mdb report type is selected) that the user wishes to write to as a report is specified by either typing directly into the MDB File textbox 263 and MDB Table textbox 264, or selecting the ‘ . . . ’ button 265 to the right of the MDB textbox 263. Selecting button 265 causes a MDB Access Details dialogue box 266 (see FIG. 20) to be displayed.

Dialogue box 266 enables the user to search for and select the .mdb file name (by entering the file name into a File Name textbox 267) and enter the relevant table name (by way of entering the table name into a Table Name textbox 268). The file name can be manually entered into the textbox 267, or by using a File Name button 269 which enables the user to browse for the file. A “prompt if MDB existing” checkbox (not depicted) gives the user the option to warn them if the file exists before overriding. The checkbox is unchecked by default. Clicking on an OK button 270 of the box 266 enters the file name and table name data, and closes the box 266. Clicking on the CANCEL button 271 closes the box 266 without entering the file name and table name data.

MDB Export is presently not capable of appending to an existing database. Selected data should be uploaded from the mdb to a central database if this is required.

Referring to FIG. 19 again, a Report Page Size listbox 272 enables the user to select the report paper size (A3 or A4) and/or paper orientation (Portrait or Landscape).

Referring to FIG. 21, after the samples have been selected and the group and or item data has been determined, the Fields to Add to Export tree 253 will begin to populate. From tree 253, group and/or item categories and properties of the selected sample can be seen. Each category and property has its own checkbox 254. Selecting a category (e.g. element) will include all the properties within that category. A category can also be expanded and the properties that wish to be included in the report can then be manually selected by checking the appropriate textboxes 254. After a check box is selected, the corresponding item is included in the content grid 255.

Referring again to FIG. 19, within the content grid 255 there are a number of columns which manage how the content in grid 255 is displayed:

A Required column 273 of the grid 255 includes a respective checkbox 274 for each row of the grid 255. Each checkbox 274 can generally be left blank/unchecked (meaning everything is required). This is used in the case where the report is for a certain purpose and a property from a different category is selected. The column 273 indicates to ignore any data that doesn't contain the selected field.

An Attribute column 275 and a Property column 276 of the grid 255 contain a respective read only value for each row of the grid 255. The values in the Attribute column 275 and the Property column 276 provide the user with a description in where the data is being drawn from what Category and Property within the model.

A Display Name column 277 contains a respective value for each row of the grid 255. The values in the column 277 are re-writable to allow a user to rename the property name to make it understandable and meet corporate standards and requirements.

A Sorted column 278 of the grid 255 contains a respective listbox 279 that sorts by the field (Asc)ending or (Desc)ending, in order from the first column selected to the last

A Group column 280 of the grid 255 contains a respective checkbox 281 for each row of the grid 255. When a checkbox 281 is selected, it will group these values by the same property.

A Hide column 282 of the grid 255 contains a respective checkbox 283 for each row of the grid 255. If a checkbox 283 is selected, it will hide the properties on its associated row when the report is produced.

A Subtotal Group column 284 of the grid 255 contains a respective listbox 285 for each row of the grid 255. When a user has grouped the report by a certain property from the model, the subgroup total will then allow the user to create a sub total group based on a certain property.

An Order column 286 of the grid 255 contains a respective integer value for each row of the grid 255. The values in the column 286 manage how the columns will be presented and where they will be placed on the report.

A Width column 287 of the grid 255 contains a respective numeric value for each row of the grid 255. The values in the column 287 manage the column width (mm) for each property on the report.

The columns that are available will vary depending on the report file type.

Dialogue box 250 also includes a textbox 290 in which is listed the names of all of the export templates.

A LOAD button 291 in the dialogue box 250 enables a user to select a template from the textbox 290 and to load the contents of the selected template into the dialogue box 250.

Clicking a SAVE button 292 in the dialogue box 250 saves any changes that have been made in the box 250 to a particular export template.

Clicking a DELETE button 293 in the dialogue box 250 will delete a selected export template.

Clicking a CLOSE button 294 in the dialogue box 250 will close the dialogue box 250 without saving any changes that have been made to an export template.

Clicking an up scroll button 295 in the dialogue box 250 scrolls upwardly through the content grid 255.

Clicking a down scroll button 296 in the dialogue box 250 scrolls downwardly through the content grid 255.

### Export Data Command

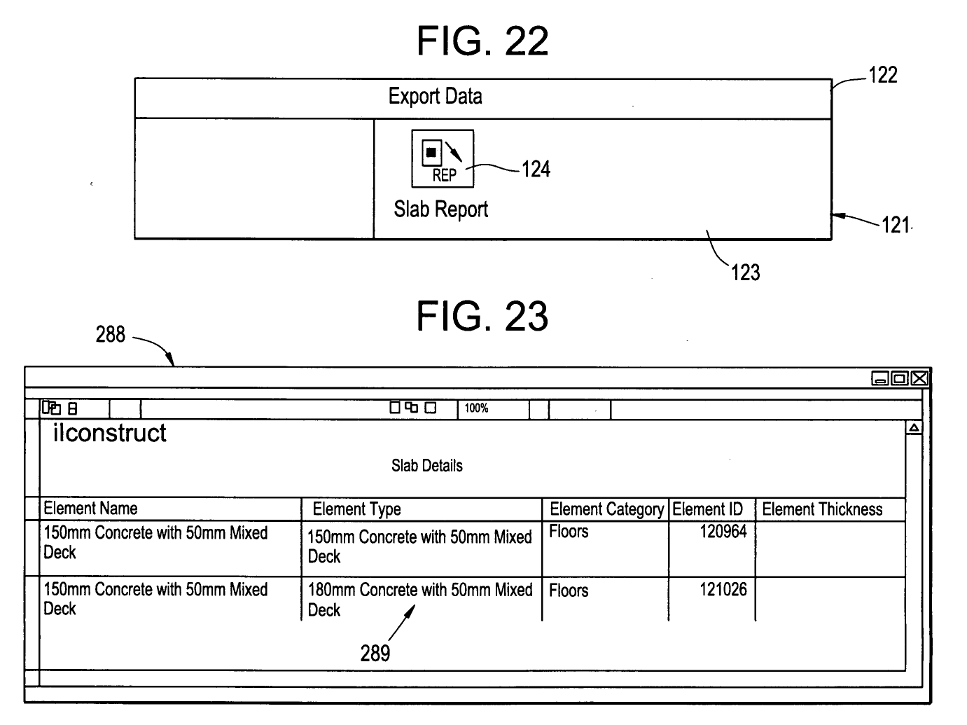

To get access to each of the Export Data tool commands that have been set up and established using the Export Configuration, select the Export Data menu 121 to expand the menu 121 as shown in FIG. 22.

To produce a report, a user selects the items within the Navisworks® model that they wish to provide a report on, and they then select the appropriate tool command button 124 from the Export Data menu 121. For Excel, MS Access and Clipboard, the report will either be written to the file or opened in the application. For the report option, the user will be displayed with a preview before having the options to save to PDF or Excel. FIG. 23 depicts a Report View window 288 in which is displayed a report 289.

### File Definition Configuration

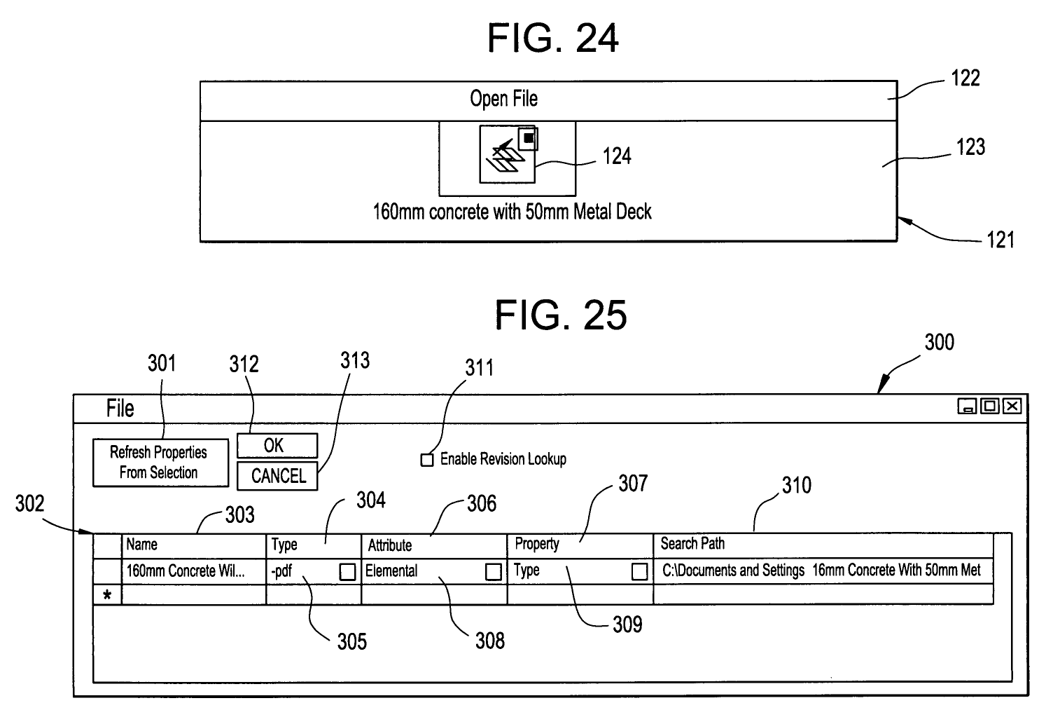

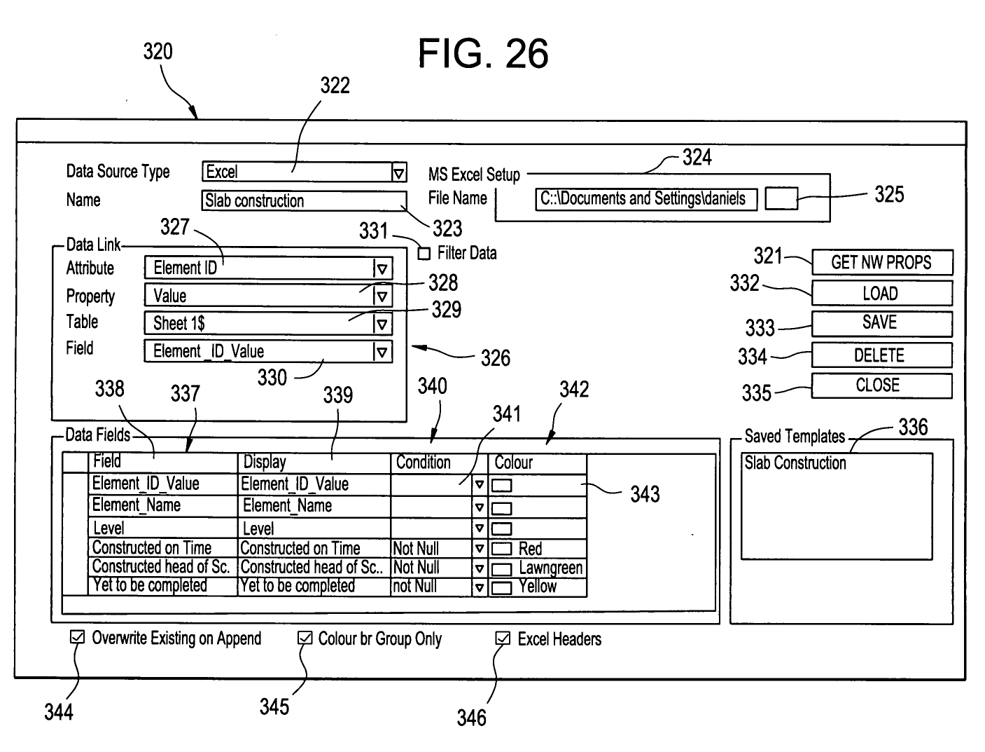

The File Definition Configuration allows a user to identify the properties to be used within the Navisworks® model as a basis for linking files. The aim when using this toolset is to identify a common relationship between the name of an external file and a property within the model, so that these files can be accessed when and where needed without having to find its location. Once a file has been linked the tool command button 124 will appear under an Open File menu 121 (see FIG. 24).

To begin the configuration, like other configurations, the user needs to select a sample item or group from the Navisworks® model to get the attributes (categories) and properties that they wish to link the model by. Once this has been done, the File Definition Configuration button 124 in the Configuration menu 121 of the application window 120 needs to be clicked so that a File Definition Configuration dialogue box 300 (see FIG. 25) is displayed.

The File Definition Configuration dialogue box 300 includes a Refresh Properties From Selection button 301 that needs to be clicked in order to retrieve the attributes and properties of the selected sample item or group.

Box 300 includes a data grid 301 that needs to be configured. There are a number of columns and options in dialogue box 300 which assist with linking the file to the model based on a relationship with a defined property:

A Name column 302 of the grid 301 includes a respective value for each row of the grid 301. Column 302 allows a user to provide a descriptive name for the linked file so end users can understand what file they are likely to open when selecting an object and running the command.

A Type column 303 of the grid 301 includes a respective listbox 304 for each row of the grid 301. The listboxes 304 allow a user to select the extension of the file type that you would like to link back to the model. All registered file types are available in the listboxes 304 (e.g., .pdf, .doc etc.)

Grid 301 also includes an Attribute column 305 and a Property column 306. The Attribute column 305 includes a respective listbox 307 for each row of the grid 301. Likewise, the Property column 306 includes a respective listbox 308 for each row of the grid 301. Listboxes 307, 308 are used to select the attribute and property field to draw the information from to create the unique relationship between the model and the name of the linked file.

A Search Path column 309 of the grid contains the search paths that are required in order to tell the file definition configuration where to open the associated file from. This search path can be an explicit path (i.e. C:\Documents\pdfs), or one of the following two keywords can be used to prompt the search:

%MODEL%—finds the .nwd or .nwd parent of the object being clicked and searches in that path. For example, if the model was an .nwf containing several .nwd files from different locations, the routine will look in those separate locations to link the file. An example of the entry into the search path may be—%MODEL%\pdf\ which will pick up and open any .pdf file with the name matching the name of the attribute of selected item within a model.

%FILE%—looks in the main file that has been opened and uses the path from this file. In the example above, using this key word it would search in the path that the .nwf resides in rather than the .nwd file. An example of the entry into the search path may be—%FILE%\pdf\.

Dialogue box 300 also includes an Enable Revision Lookup checkbox 311. Ticking the checkbox 311 means the routine will automatically find the latest available revision based on the property name plus underscore plus revision. For example, if there were two .pdf files LFS-04-1002_{—}0.pdf and LFS-04-1002_{—}1.pdf the routine would open the latter.

Clicking an OK button 312 of box 300 stores the information that has been entered into the box 300 and closes the box 300.

Clicking a CANCEL button 313 of box 300 closes the box 300 without storing any information.

Once the search paths have been set, users can run a selected command from its associated menu 121 which is entitled Open File. If the file is found it will open automatically, if the property or the file cannot be found a message will pop up with the information.

If the command that is run is to open multiple .pdf files, the plug-in application will group these .pdf files in the one viewer. This may assist where instances of batch printing is needed.

### Open File Command

To get access to the Open File Commands that have been set up and established using the File Definition Configuration, select the Open File menu 121 in the application window 120 to expand the menu 121 as shown in FIG. 24.

To run the tool command, the user must first select the associated parts of the model that they wish to open the associated file linked to the command. When the command is run, the associated files will be opened in their default viewer or application or prompt you to select an appropriate program.

For multiple PDF files, the user has the option to combine multiple PDF files into one file.

### Colour Code Configuration

The Colour Code configuration button 124 in the Configuration menu 121 of the application window 120 allows a user to set up links to external forms where other users can provide feedback on the Autodesk® Navisworks® model and its elements, and have this brought back in to the Navisworks® model and group the designated variables under an assigned colour scheme. This additional data can also be stamped into an assigned re-writable data tab in Navisworks®. The Colour Code tool works based on using a unique matching attribute that is present in the model and external form, to set up a link between the two. After the settings have been configured and the template has been saved, the command will appear under the Colour Code menu.

The export data tool command compliments the colour code tool command in that the internal properties of objects can be exported, some additional fields can be inserted for users to fill out, and then read back into the colour code tool command to create groups for viewing. The Colour Code configuration supports linking to Excel, MS Access and ODBC.

At the beginning of the colour configuration, a user needs to select a sample of the data to give a range of the properties that can be used to use to set up a link between the model and external form. After selecting the sample items from the sample and clicking on the Colour Code configuration button 124, a Colour Code Setup dialogue box 320 is displayed. The user needs to select a Get NW Props button 321 in the dialogue box 320 to retrieve the properties of the selected sample items of the Navisworks® model. The user also needs to choose the external data source that they wish to link to so that they are able to configure the link and data fields.

The time taken for the Colour Code command to operate relies on the number of Navisworks® objects to colour, the number of Excel fields to colour by, the number of fields to search in the external file, and whether data is going to be appended. Breaking the model up into smaller groups and areas may help speed up this process if performance issues are experienced.

There are a number of fields and options in the Colour Code Setup dialogue box 320 that will help with setting up a colour code command:

A Data Source Type listbox 322 allows the user to select the type of external data source that they wish to connect the Colour Code Command too.

A Name textbox 323 allows the user to enter the name to be assigned to the template and its associated colour code command name.

A File/DSN Name textbox 324 allows the user to enter the name of the external file/database that the Colour Code command will connect to gather user data/feedback to group the model based on pre-determined variables. The path and name can be entered manually into the textbox 324, or a File Name button 325 can be used to browse for the file and to enter its path and name into the textbox 324.

A Data Link group 326 is used to determine the model's attributes in Navisworks® and that will be linked to a field from an external data source. Here, the user needs to indicate the Navisworks® models:
Attribute (in an Attribute listbox 327); and
Property (in a Property listbox 328).

And the external data sources:
Table (in a Table listbox 329); and/or
Field (in a Field listbox 330).

A Filter Data checkbox 331 can be used to extract only certain information from the external data source to be used for the colour code command, e.g. values greater or equal to 100.

As mentioned previously, the GET NW PROPS button 321 retrieves the fields from the sample data to be used when configuring the colour code command.

A LOAD button 332 on the dialogue box 320 is clicked to load the properties of a saved colour code configuration template into the dialogue box 320.

A SAVE button 333 on the dialogue box 320 is clicked to save the current configuration to a new template or update an existing template.

A DELETE button 334 on the dialogue box 320 is clicked to delete a saved colour code configuration template.

A CLOSE button 335 on the dialogue box 320 is clicked to close the Colour Code Setup dialogue box 320.

A Saved Templates textbox 336 in the dialogue box 320 list all of the saved colour code tool command templates.

The Colour Code Setup box 320 also includes a Data Fields grid 337. After the link is established, the grid 337 is used to configure the grouping and presentation after running the colour code command. The different columns and options in this grid will assist with this part of the configuration:

A Field column 338 of the grid 337 contains the fields from the external data source.

A Display column 339 of the grid 337 includes re-writable fields where a user can customise the display names of the attributes and variables that will be displayed on the Colour Legend and names of selection set results.

A Condition column 340 of the grid 337 includes a respective listbox 341 for each row of the grid 337. The listboxes 341 allow a user to select a condition that is used when the user wants to establish a field as a variable in which a colour is to be assigned to. Four conditions can be selected: Not Null, >0, True and False. When this is set the colour code command will use this condition when reading the external data source to see if the attribute falls within that variable.

A Colour column 342 of the grid 337 includes a respective colour selection control 343 for each row of the grid 337. The colour selection controls 343 are used to assign a colour that it is to be applied to the relevant object that meets the condition of the variable field.

If an Overwrite Existing on Append checkbox 344 of the dialogue box 320 is selected, it will overwrite an existing value that may be applied to an object with the latest value.

If a Colour by Group Only checkbox 345 of the dialogue box 320 is selected, it will run the search for the attributes by Navisworks® group and colour by group. If this can used, it will increase the performance of the colour code command. For example, a medium model may have 30,000 items, but they are contained within 7,500 groups—if the user colours based on information on the group it will run in a quarter of the time.

There are a few items that need to be noticed when working with external data sources:

Excel: the Excel reader scans the first several rows of a spreadsheet to determine the ‘data type’ be it a number, text, date or Boolean (true/false) value. It may be advisable to have a calibrate row under the header of the spreadsheet with a sample of the data that will be listed below. The sample data should not match the data below as if it matches a value in the linked column it will perform the Colour Code on the item with the dummy field data appended. Selecting an Excel Headers checkbox 346 of the dialogue box 320 indicates to the program that the Excel file is formatted in such a way that the first row contains the field names and not actual data. If the checkbox 346 is unticked, then the default system field names F0, F1, F2 etc. applies to the data. This is used in the case that either there is no header row in the spreadsheet, or the header is complicated and consists of merged cells or multiple rows. The user would then make a note of which field name represented which column of data.

### Colour Code Command

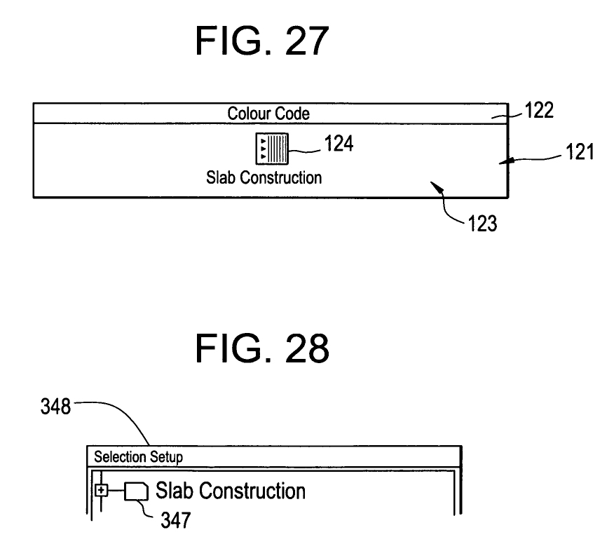

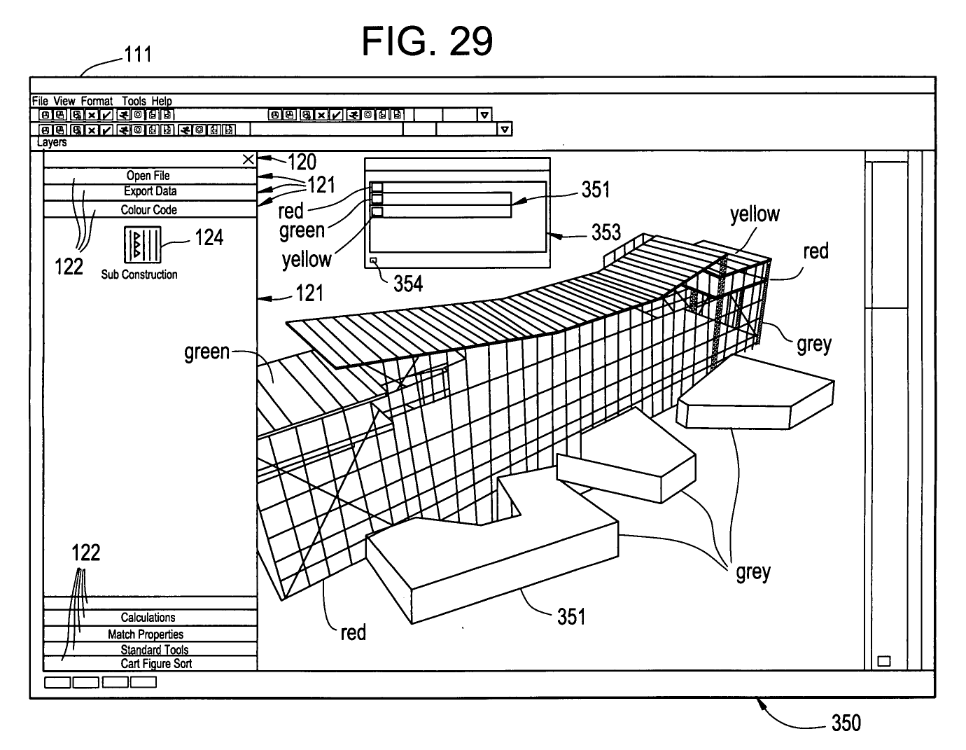

In order to get access to the Colour Code Commands that have been set-up and established using the Colour Code Configuration, the Colour Code menu 121 is expanded by selecting it. The expanded Colour Code menu 121 is depicted in FIG. 27. The Colour Code menu 121 includes a Slab Construction tool command button 124

To perform a Colour Code routine from the latest data of the selected Data Source, the user needs to make sure that the source is closed, and then select the relevant Colour Code Command tool from the Colour Code menu 121. The plug-in application will then check the data source and co-ordinate the model by the predetermined colours for the variables and group into ‘selection sets’ 347 in a Selection Sets window 348.

FIG. 29 depicts the Autodesk® Navisworks® application window 350 in which the plug-in application window 120 is floating. A three-dimensional model 351 of an object is displayed in the application window 350. The various parts of the model 351 are coloured in accordance with a legend 351 that is displayed in a Legend dialogue box 353. The dialogue box 353 includes a Highlight Tasks checkbox 354 that, if selected, identifies which of the tasks applies to the selected item, and highlights the rows in the legend accordingly. This is useful where tasks may be skipped for one item but not another, but both items have the final task assigned and therefore both would be the same colour.

The results from the Colour Code command can be removed by closing the Legend dialogue box 353, deleting the selection sets 347 and resetting colours and transparencies.

The Colour Code Command will not attach colours to models that have presenter materials applied to it.

### Integrator Configuration

The Integrator tool command allows a Navisworks® user to create their own custom data tabs within Navisworks® and take data from one or more read-only data tabs and combine them into the custom data tab. This is used in situations where companies may want standardisation of what data they want displayed when selecting an object in a model and or to reduce the hassle of having to need to look in different tabs and different properties for the required information. This could also be used at a project level where a user may be receiving models from different sources and needs to set up a project or company specification based on standard required properties The Integrator tool command provides the option to configure and create a user defined data tab for both Item and Groups within the Navisworks® model.

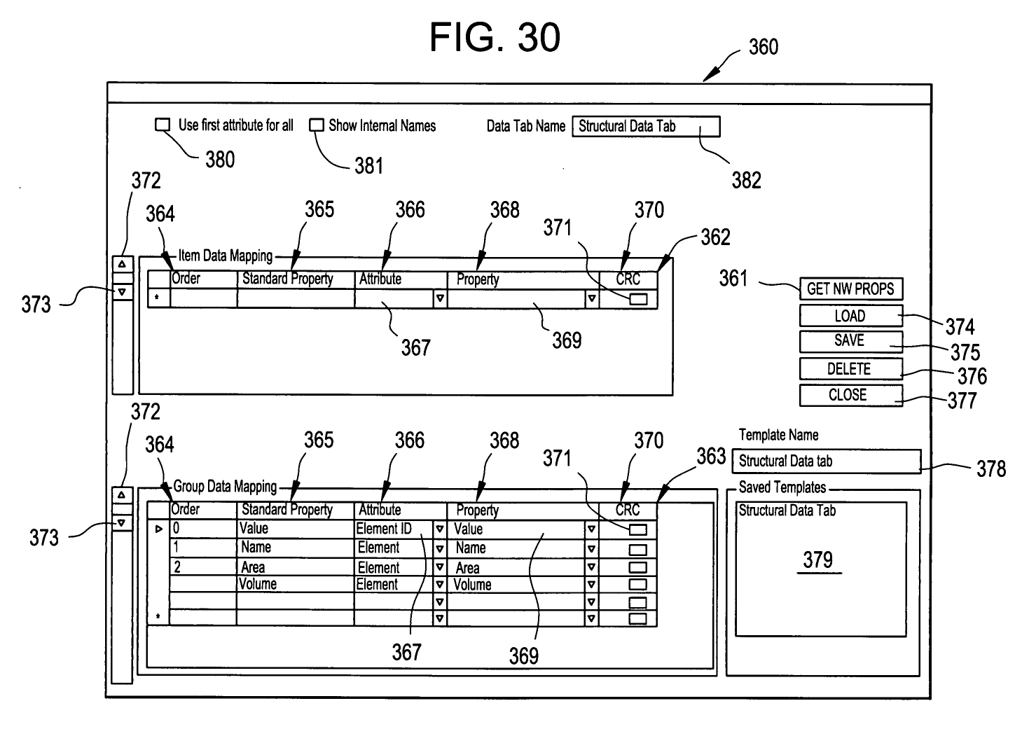

To begin the configuration, a sample needs to be selected from the model, and then the Integrator Configuration button 124 in the Configuration menu 121 of the application window 120 needs to be clicked to open an Integrator Configuration dialogue box 360 (see FIG. 30). Depending on whether the user is working with Integrator on Items or Groups, they will need to make sure the sample that they have selected suits the level they are working on.

A GET NW PROPS button 361 is clicked to collect the properties/fields from the selected sample item or group data to be used in Integrator in setting up the custom user tabs.

After the sample properties have been retrieved from the model, the user can then begin to set-up the custom user tab using a configuration grid 362 or a configuration grid 363. Configuration grid 362 is set-up if the sample is a sample item. Configuration grid 363 is set-up if the sample is a sample group.

There are a number of columns in grid 362, 363 that assist with the process:

An Order column 364 of the grid 362, 363 contains a respective integer value for each row of the grid 362, 363. The order in which the property will be displayed in the custom user tab is determined by the values in the column 364.

A Standard Property column 365 of the grid 362, 363 displays the name that will be given to each property inside of the custom user tab. This can be used to create a standardisation in terminologies for properties within models.

An Attribute column 366 of the grid 362, 363 includes a respective listbox 367 for each row of the grid 362, 363. The particular attribute displayed in the listbox 367 is able to be selected from the internal Navisworks® attribute that the Integrator will be collecting the data from to include on the custom user tab.

A Property column 368 of the grid 362, 363 includes a respective listbox 369 for each row of the grid 362, 363. The particular property displayed in the listbox 367 is able to be selected from the internal Navisworks® property that the Integrator will be collecting the data from to include on the custom user tab.

A CRC column 370 of the grid 362, 363 includes a respective checkbox 371 for each row of the grid 362, 363. A feature of the Integrator which provides the ability to check if data has been modified from the original running of the command—this is activated by checking the checkboxes 371 next to the properties deemed as important. As a custom user tab and its fields are rewriteable, this functionality is important for testing the integrity of the data.

Up-scroll buttons 372 and down-scroll buttons 373 can be clicked to scroll-up and down through the grids 362, 363.

There are a number of other items in dialogue box 360 that will make the Integrator work:

A LOAD button 374 is clicked to load a saved Integrator configuration template.

A SAVE button 375 is clicked to save the current configuration to a new template or update an existing template.

A DELETE button 376 is clicked to delete a saved Integrator configuration template.

A CLOSE button 377 is clicked to close the dialogue box 360.

A Template Name textbox 378 displays the name to be assigned to or already assigned to the template.

A Saved Templates textbox 379 displays a list of the already saved Integrator templates. When selected, these can be opened for editing and resaved or deleted.

If all the properties are from one tab, a Use first attribute for all checkbox 380 can be selected in order to make the attribute field the same as the first for the whole list.

If a Show Internal Names checkbox 381 is checked, a read only column is displayed in the configuration grid 362, 363 of the internal property names of items selected within the model. This can be used if a user has renamed the ‘standard name’ in the Standard Property column 365 of the configuration grid 362, 363 to a standard terminology, and needs to check what property it relates to.

A Data Tab Name textbox 382 displays name of the customised data tab inside of Navisworks® when the Integrator command is run.

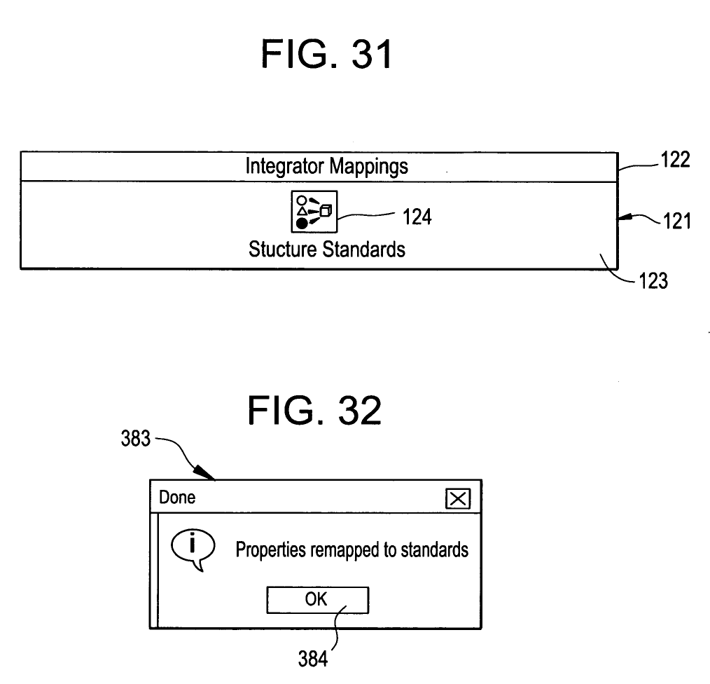

Once a template has been saved, an integrator command button 124 will appear in the Integrator Mappings menu 121 (see FIG. 31).

### Integrator Mapping Command

To map the standards that have been established in the templates established in Integrator Configuration, the Integrator Mappings menu 121 is expanded as shown in FIG. 31.

To map the properties to a standard, the relevant items and/or groups to which the user wishes to map the standards are selected, and then the relevant Integrator Mappings command button 124 is selected from the Integrator Mappings menu 121.

If the standards are mapped successfully, the message box 383 depicted in FIG. 31 is displayed. The message box 383 includes and OK button 384 for closing the box 383.

The model needs to be saved in order for the mapped properties to remain within the model. If the model is not saved, the command can be rerun at another time.

### Data Link Configuration

Data Link is a powerful tool that provides the ability to bring in related information from external data sources and display it within the Navisworks® model. Once a link is established, the data will save itself to a rewritable tab (see Integrator) that the user has set-up. The Data Link configuration is best used by users who have some knowledge of the database system, once set up however; it is simply a mouse click on the command to import the data into Navisworks®. When configured properly, the Data Link tool can add value to consultants and construction professionals by providing additional project related information within the model for viewing when and where needed.

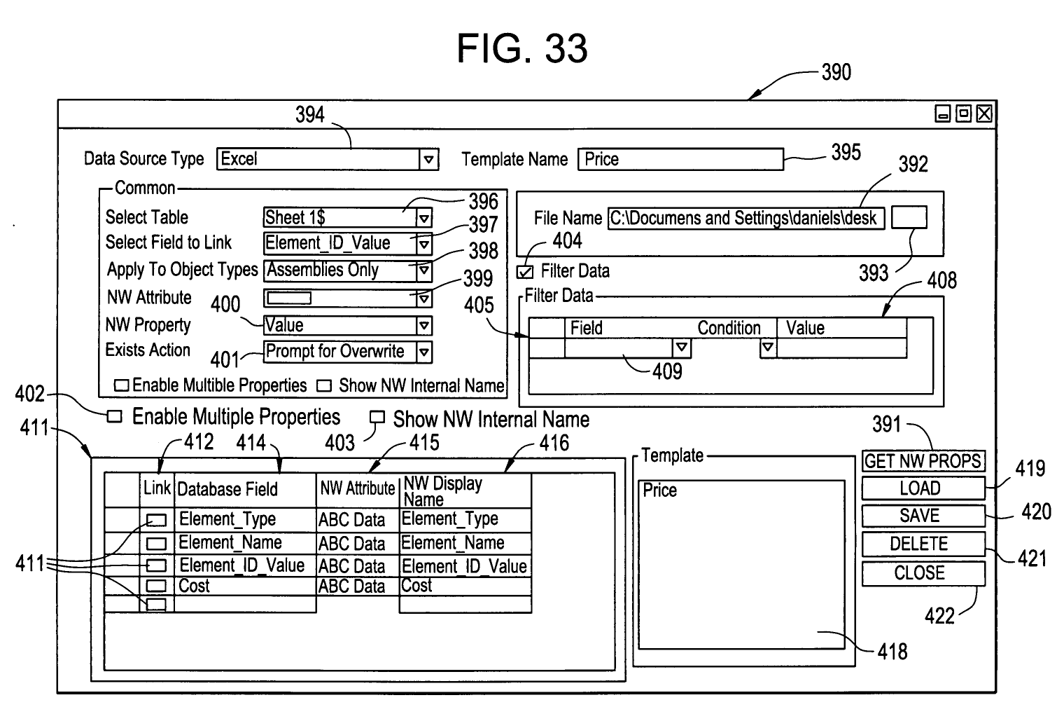

To begin the Data Link configuration a user needs to select a sample from the model, and then open the Data Link Configuration window/dialogue box 390 (see FIG. 33). With the configuration window 390 open and the sample selected, the user then needs to select a GET NW PROPS button 391 to identify the attributes and properties of the sample that the external data is going to be written to.

The user also needs to identify the external data source that they wish to connect to. Box 390 includes a File Name textbox 392 for entering the location and file name of the data source. This information can be typed into the textbox 392 manually, or the user can press a File Name button 393 to browse for the file and its location and then have this information automatically entered into the textbox 392. Data Link supports links to Excel, MS Access and ODBC, with the method to configure Data Link for each being the same. For the link to work there must be a unique variable that exists in the Navisworks® model and that is able to match up with a similar one in the external data source in order to bring its associated data across into the right item or group.

There are a number of areas on the Data Link Configuration window 390 that will help in setting up the link between the Navisworks® model and the external data source:

A Data Source Type listbox 394 allows the user to select the external data source type that they wish to connect to. The data source type can be an Excel, MS Access or ODBC data type, in the embodiment described.

The name that the template will be saved under is entered in a Template Name textbox 395. The same name is used for the command (when template saved) under the Data Links menu 121

The table from within the external data source that the user wishes to connect to draw the external data from and into the defined Navisworks® properties tab is selected from a Select Table listbox 396.

The field within the table from the external data source that the user wishes to use as part of the link to the Navisworks® model is selected from a Select Field to Link listbox 397.

The user can select whether the information will be applied to the Navisworks® model's groups and/or items by making an appropriate selection using an Apply To Object Types listbox 398.

The attribute re-writable data tab that Data Link will search within for the similar value as in the external data source to create the link and also the tab to which the external property will be written is selected using a NW Attribute listbox 399.

The property field that the external data value will write to is selected from a NW Property listbox 400.

An Exists Action listbox 401 is used to tell the DataLink command what to perform when its function is run, the link is established and a value already exists in the selected property. There are three options that can be selected by the user: Don't Overwrite, Prompt for Overwrite and Always Overwrite.

An Enable Multiple Properties checkbox 402 is used to change the mode of operation from selecting the first matching returned record as the designated property, to applying all returned records. For example, if a data source has the linked property listed three times, each with a different property for the one that is to be added, it would be added as three separate properties in the tab as for example ‘Property Display Name’, ‘Property Display Name2’ and ‘Property Display Name3’. The number is automatically appended to the specified Display Name.

Selecting a Show NW Internal Name checkbox 403 will enable and display the Navisworks® internal property names in the configuration grid. This will assist if the user decides to change the display name and needs to make sure they know the internal Navisworks® properties that it represents.

Checking a Filter Data checkbox 404 allows the user to apply rules to control what information that is brought in from the external data source with the Data Link tool. This is presented as a Filter Data grid 405 that includes a Field column 406, a Condition column 407, and a Value column 408 containing the value that the user wishes to use as the benchmark or determining value for the condition applied. The Field column 406 includes a respective listbox 409 for each row of the grid 405. Listbox 409 is used to select the field from the external data source that the user is bringing into the Navisworks® model's properties that they wish to filter. The Condition column 407 includes a respective listbox 410 for each row of the grid 405. Listbox 410 is used for selecting the rule that the user wishes to apply to the filter to control which information is brought across. This can be an equal to, greater or less than or like condition.

Once the link is established, the user is then able to use a configuration grid 411 to manage what data from the external source is brought in to the user created properties tab in Navisworks®.

A Link column 412 of the grid 411 includes a respective checkbox 413 for each row of the grid 411. Checkboxes 413 are used to select which external properties the user wishes to bring into the Navisworks® user created properties tab.

A Database Field column 414 of the grid 411 identifies the external field that the user is bringing in to the user-created properties tab.

A NW Attribute column 415 of the grid 411 identifies the attribute (or user-defined tab name) that the external information will be writing to.

A NW Display Name column 416 of the grid 411 identifies the display name of the property that will be created in the user defined data tab.

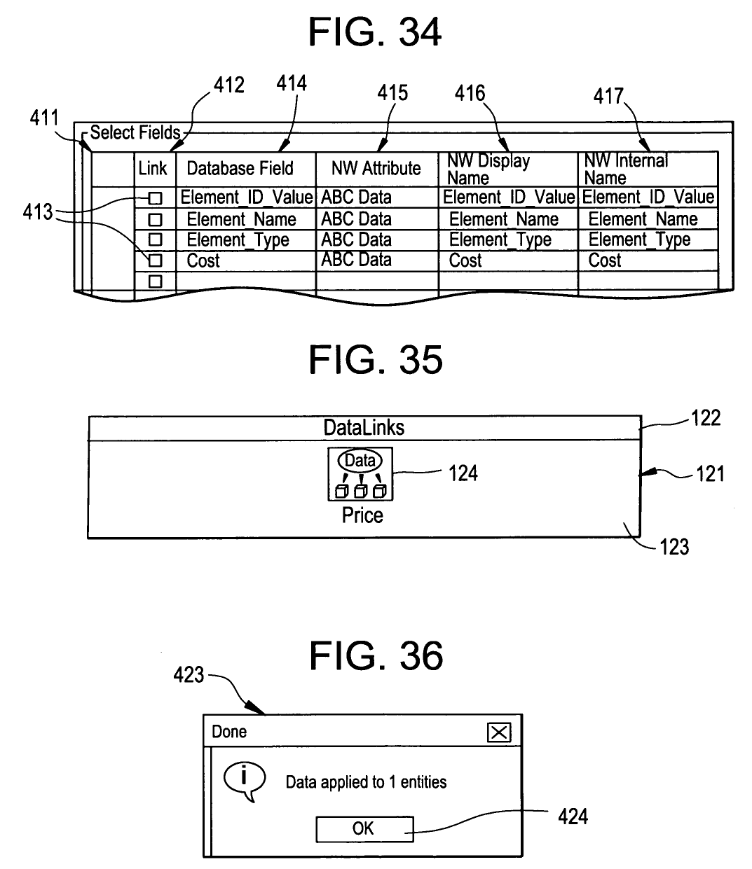

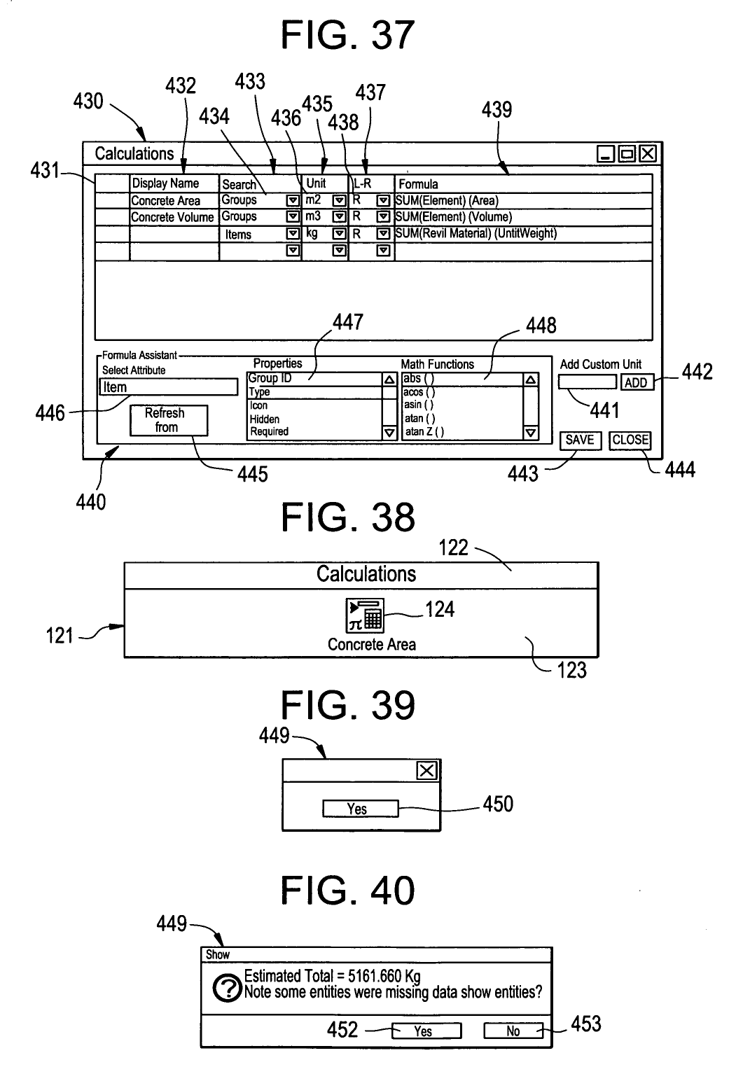

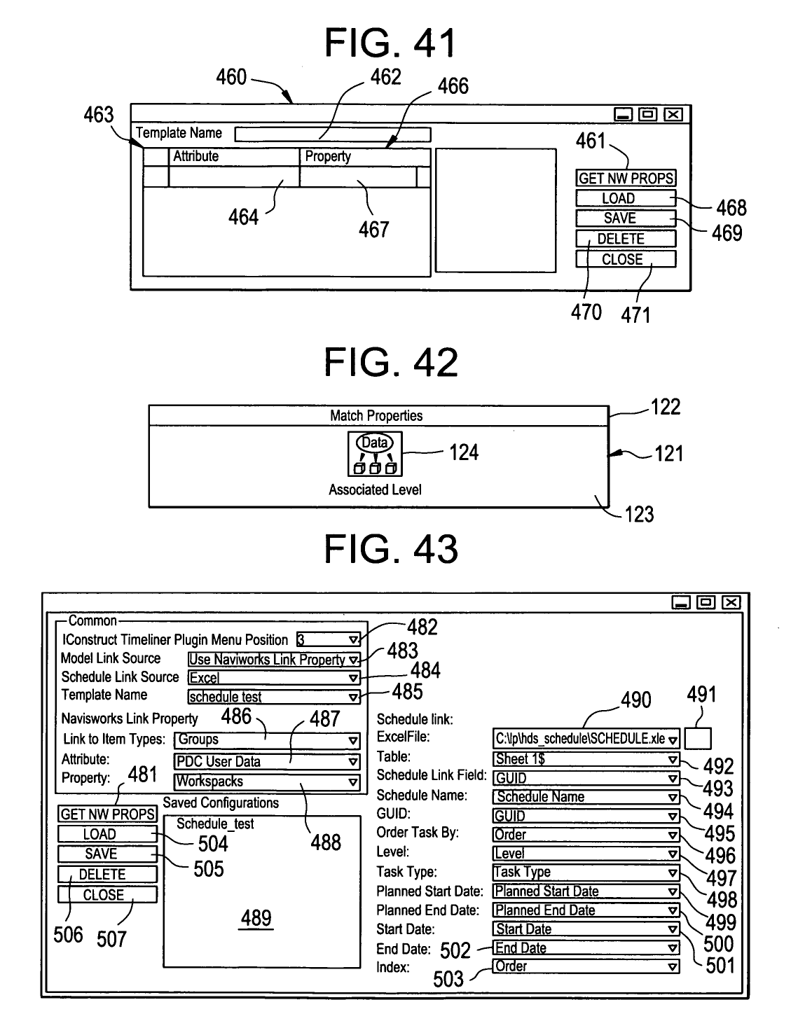

Referring to FIG. 34, a NW Internal Name column 417 of the grid 411 identifies the internal name of the value, this internal name should match the project or company internal name for consistency of data throughout the model.

When running the Data Link command, data is only applied to the selection, or if nothing is selected, to everything.

Dialogue box 390 also includes a textbox 418 in which is listed the names of all of the export templates.

A LOAD button 419 in the dialogue box 390 enables a user to select a template from the textbox 418 and to load the contents of the selected template into the dialogue box 390.

Clicking a SAVE button 420 in the dialogue box 390 saves any changes that have been made in the box 390 to a particular export template.

Clicking a DELETE button 421 in the dialogue box 390 will delete a selected data link template.

Clicking a CLOSE button 422 in the dialogue box 390 will close it without saving any changes that have been made to a data link template.

### DataLink Command

To establish a connection to the link that has been established through the commands created in the DataLink Configuration, the user needs to select the DataLinks button bar 122 in the application window 120 to expand the Datalinks menu 121.

To establish a link and import the data from the external data source, the user selects the associated items and or groups that the data needs to be applied to, and then selects the relevant command button 124 from the DataLinks menu 121 (see FIG. 35). If the data has been successfully applied to the defined properties tab, a message box 423. Message box 423 is closed by clicking an OK button 124.

The model will need to be saved for the DataLink data brought in from the external source to remain within the model. Updated data can be brought in through re-running the command on relevant items.

### Calculations Configuration

The Calculations Configuration button 124 on the Configuration menu 121 allows a user to create calculation commands that can be used by the end user where and when needed to give them totals on selected items based on predefined calculations (e.g. weight load). The Calculations Configuration allows the use of the JavaScript maths library to perform calculations on the sum of properties. Once a Calculation Configuration template is save, it will be added as a command to the Calculations menu 121.

As the Calculation tool provides totals from the internal properties of the Navisworks® model, at the beginning of configuration the user needs to select a sample from the model on where they are going to get the attributes and properties from to calculate.

After clicking on the Calculations Configuration button 124 in the Configurations menu 121, a Calculations dialogue box 430 is displayed. Dialogue box 430 includes a grid 431. There are a number of fields on the configuration window 430 that are used to set up a Calculation command:

A Display Name column 432 of grid 431 contains the names that will be given to the commands in the Calculations menu 121.

A Search column 433 of grid 431 contains a respective listbox 434 for each row of the grid 431. The listbox 434 contains a list of where the calculation command will search to gather the values to conduct the preset calculation. This can be by Groups, Items or both.

A Unit column 435 of grid 431 contains a respective listbox 436 for each row of the grid 431. The listbox 436 contains a list of the display units that will appear next to the value when the calculation is performed.

A L-R column 437 of grid 431 contains a respective listbox 438 for each row of the grid 431. Whether the unit will appear to the left or right of the total value can be selected from the listbox 438.

A Formula column 439 of grid 431 contains the formula that will be used and where to get the values from the Navisworks® properties in the model to perform the calculation. The JavaScript maths family can be used to create a formula in this box manually, or a Formula Assistant 440 can be used.

If a display unit is not available in the default Unit listbox 436, a user can create one by typing it into an Add Custom Unit textbox 441 and clicking an ADD button 442 which will add it to the menu in the listbox 436 for future use.

Clicking a SAVE button 443 in the dialogue box 430 saves the current formulas and updates the Calculation commands in the tool menu 121.

Clicking a CLOSE button 444 in the dialogue box 430 closes the Calculation Configuration dialogue box 430 without saving the current settings, unless the user has already clicked the SAVE button 443.

If a user has not had experience using JavaScript calculations, they can use the Formula Assistant 440 to reach a desired result. Below is a guide on how to use the Formula Assistant 440:
1) To add a new calculation command, the user types the name in the Display Name column 432, e.g. ‘Estimated Mass’, selects the objects to search on (Items, Groups, or both) from the listbox 434 in the Search column 433, and then selects the unit to display from the listbox 436 in the Unit column 435.
2) Then to build the formula, the user clicks a Refresh from button 445 (first making sure a correct sample is highlighted) in the Formula Assistant 440 box and then selects an attribute from a Select Attribute listbox 446. A Properties listbox 447 will then populate.
3) Then, the user highlights in the Properties listbox 446 the property they wish to add to the formula, and drags it to the appropriate row in the Formula column 439 by holding down the left mouse button on the property, moving to the Formula column 439, and then releasing the left mouse button.
4) The Formula column 439 will automatically add the Attribute name and the SUM( ) keyword. Parts of the formula inside the parenthesis will be evaluated for each object and added together. Outside of the SUM( ) statement other calculations can be placed to make use of the total result, but no properties should be outside of the SUM( ) statement.

If the calculation needs to be something other than the SUM of the values, the user can use the Math Functions listbox 448 by simply dragging the required calculation from the Math Functions listbox 448 into the appropriate row of the Formula column 439.

When using the Math Functions listbox 448, the user will need some understanding of the JavaScript maths family to complete the formula. If they don't have a guide, one can typically be found on the Internet. Properties can still be dragged from the Properties listbox 447, and as the user holds the mouse cursor over the formula the caret will appear, showing where the property will be inserted.

After each formula is saved, it will become available as a command under the Calculations menu 121.

### Calculation Command

To run a calculation on properties of items or groups based on formula's created in the Calculation Configuration, the user needs to select the button bar 122 for Calculations menu 121 to expand that menu as shown in FIG. 38.

To get a calculated total, the user selects the items or groups within the model that they wish to collect a total on, and then selects the relevant Calculation Command from the Calculations menu 121. If the calculation has performed successfully, a message box 449 (see FIG. 39) will appear in which is displayed (in this particular instance) a complete total. Clicking an OK button 450 will cause the message box 449 to close.

If the calculation command is unable to find the values on all selected items to perform the calculation, a Show? message box 451 (see FIG. 40) is displayed. Clicking a Yes button 452 of the box 451 will show the items with the value error and close the message box 451. Clicking a No button 453 of the box 451 will close it without showing the items with the value error.

### Match Properties Configuration

The Match Properties is a useful tool that can be used to find like items within the model, of a certain property, to that of one selected. This can help speed up the process for consultants and construction professionals to be able to quickly find all similar items instantly without having the need to set up filters and or using find items.

The Match Properties Configuration allows a user to set up a number of templates to be used as commands in the Match Properties Menu. To begin the configuration, as the user is setting-up templates to find like items based on certain attributes and properties, the user needs to highlight a sample and then, after clicking on a Match Properties Configuration button 124 in the Configuration menu 121 to display a Match Properties Configuration dialogue box 460, select a GET NW PROPS button 461 in the dialogue box 460.

A number of selections within the Match Properties Configuration dialogue box 460 assist with setting up the user's templates and commands:

The name that will be assigned to the template and also the name given to the command in the Match Properties menu 121 once saved or updated is entered into a Template Name textbox 462.

Dialogue box 460 includes a grid 463 that includes an Attribute column 464 that includes a respective listbox 465 for each row of the grid 463. The attribute (or properties data tab) from the Navisworks® sample that the user wishes to use to find like items with is selected from the listbox 465.

Grid 463 also includes a Property column 466 that includes a respective listbox 467 for each row of the grid 463. The property (within the attribute or data tab) from the Navisworks® sample that the user wishes to use to find like items with is selected from the listbox 467.

Clicking a LOAD button 468 of the dialogue box 460 loads a selected saved template into the dialogue box 460 for editing or viewing.

Clicking a SAVE button 469 of the dialogue box 460 saves a new template or changes made to an opened template.

Clicking a DELETE button 470 of the dialogue box 460 deletes a selected template from the list.

Clicking a CLOSE button 471 of the dialogue box 460 closes the configuration window 460 without saving changes (unless already saved).

### Match Properties Command

To use the Match Properties command on a model based on templates created in the Match Properties Configuration, the user selects the Match Properties button bar 122 from the application window 120 to expand the Match Properties menu 121.

To find like items using the Match Properties command, the user selects the item(s) within the model that they wish to match, and then selects the relevant command from the Match Properties menu 121 to find others in the group. Once the command is run, the other like items will highlight so they can be grouped into selection sets in Navisworks®.

### Scheduling Properties Configuration

The plug-in application also contains a scheduling routine that loads data into Navisworks® Timeliner, an application for use in creating simulations in Navisworks®. TimeLiner imports schedules from a variety of sources, allows users to connect objects in a Navisworks® model with tasks in the schedule, to simulate the schedule showing the effects on the model, including planned against actual schedules, and to export images and animations based on the results of the simulation.

In the embodiment described, the plug-in application is able to link into Excel, MDB (Microsoft Access Database) or ODBC (Open Database Connectivity) data sources, for example, instead of just scheduling software, and it also can be set to use an intermediary mapping file to assign workpacks, i.e. if the workpack property of an item or group is not already existing on the object, but the mark is, it will look-up a table matching the mark to the workpack. This reduces the amount of work required if items are to have their workpacks reassigned as it requires only a value in a spreadsheet/database to be changed instead of something directly in the model, and also allows for the workflow to be more dynamic as the database can be directly manipulated by third-party applications (i.e. hundreds of records can be modified quickly using other routines).

To configure a Scheduling command, a sample schedule data source needs to be selected, and the Scheduling Configuration button 124 (not shown) in the Configuration menu 121 is clicked so that a Schedule Config dialogue box 480 (see FIG. 42) is displayed. A GET NW PROPS button 481 in the dialogue box 480 is then clicked to obtain the properties of the sample.

In addition to the GET NW PROPS button 481, the Schedule Config dialogue box 480 includes the following items:

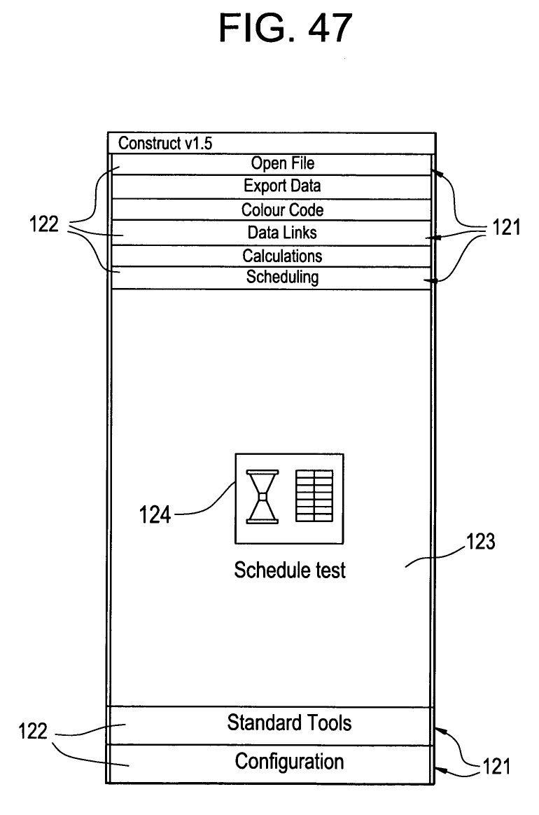

Plug-in Menu Position listbox 482 which enables a user to select the position of the Scheduling command button 124 in a Scheduling menu 121 (see FIG. 47) of the application window 120.

A Model Link Source listbox 483 which enables the user to select the model link source, including whether the Navisworks® link property is to be used.

A Schedule Link Source listbox 484 which enables the user to select the schedule link source, such as an Excel schedule link source.

A Template Name textbox 485 in which the name of the template is entered. The name in the textbox 485 appears on the Scheduling command button 124 for the template.

Dialogue box 480 also includes Link to item Types listbox 486 which allows the user to select whether to link to an item or to a group of items of the Navisworks® model.

An Attribute listbox 487 allows the user to select the Navisworks® attribute of the data.

A Property listbox 488 allows the user to select a property, including the Workpack property.

A Saved Configurations textbox 489 lists the names of the different templates that have been created and that have corresponding command buttons in the Scheduling menu 121.

A File textbox 490 is used to specify the path and name of the file (e.g. Excel file) which contains the scheduling data. This information can be entered manually into the textbox 490, or it may be entered by pressing a button 491 that enables the user to browse for the file and to enter the path and name of the file into the textbox 490.

A Table listbox 492 is used to select the particular table of the file specified in the File textbox 490 from which the schedule data is to be taken.

A Schedule Link Field listbox 483 is used to select the field in the sample schedule data that is to be linked to.

A Schedule Name listbox 494 allows the user to select the name of the sample schedule data.

A GUID listbox 495 is used to select a particular GUI.

An Order Tasks By listbox 496 allows the user to select the order in which the tasks are listed.

A Level listbox 497 allows the user to specify the level.

A Task Type listbox 498 allows the user to select the type of the task.

A Planned Start Date listbox 499 enables the user to select the planned start date.

A Planned End Date listbox 500 enables the user to select the planned end date.

A Start Date listbox 501 allows the user to select the start date.

An End Date listbox 502 allows the user to select the end date.

An Index listbox 503 allows the user to select the index.

Clicking a LOAD button 504 of the dialogue box 480 loads a selected saved template into the dialogue box 480 for editing or viewing.

Clicking a SAVE button 505 of the dialogue box 480 saves a new template or changes made to an opened template.

Clicking a DELETE button 506 of the dialogue box 480 deletes a selected template from the list.

Clicking a CLOSE button 507 of the dialogue box 480 closes the configuration window 480 without saving changes (unless already saved).

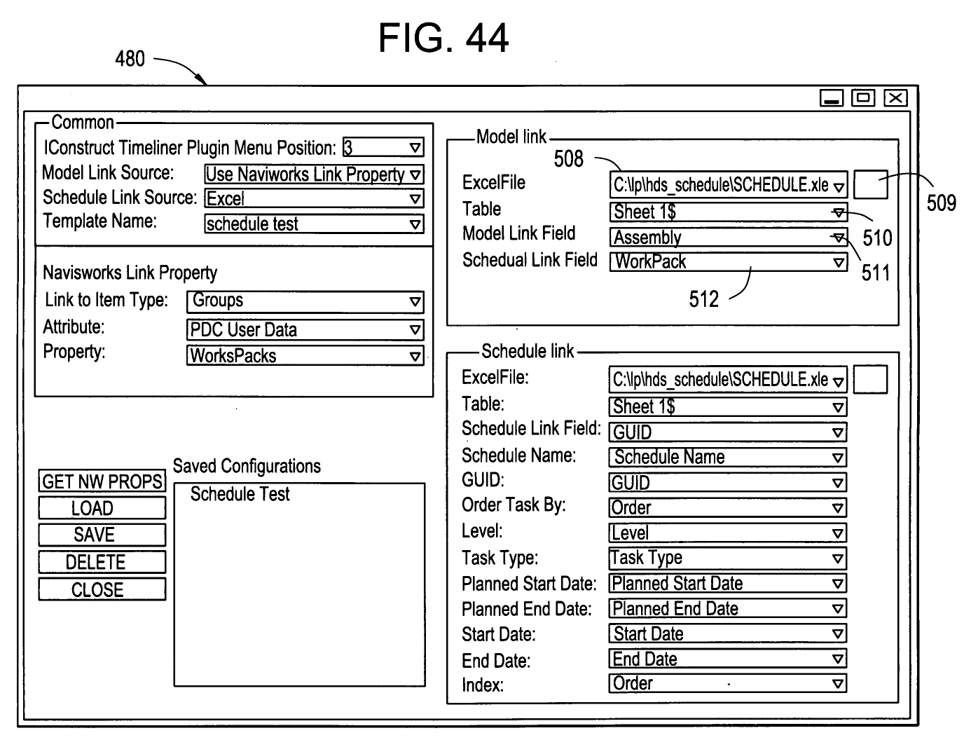

Referring to FIG. 44, if an intermediary mapping file is used to assign workpacks, the dialogue box 480 also includes the following items:

A File textbox 508 is used to specify the path and name of the file (e.g. Excel file) which contains the mapping data. This information can be entered manually into the textbox 508, or it may be entered by pressing a button 509 that enables the user to browse for the file and to enter the path and name of the file into the textbox 508.

A Table listbox 510 is used to select the particular table of the file specified in the File textbox 508 from which the mapping data is to be taken.

A Model Link Field listbox 511 is used to select the field in the mapping data that is to be linked to.

A Schedule Link Field listbox 512 is used to select the field in the sample schedule data that is to be linked to.

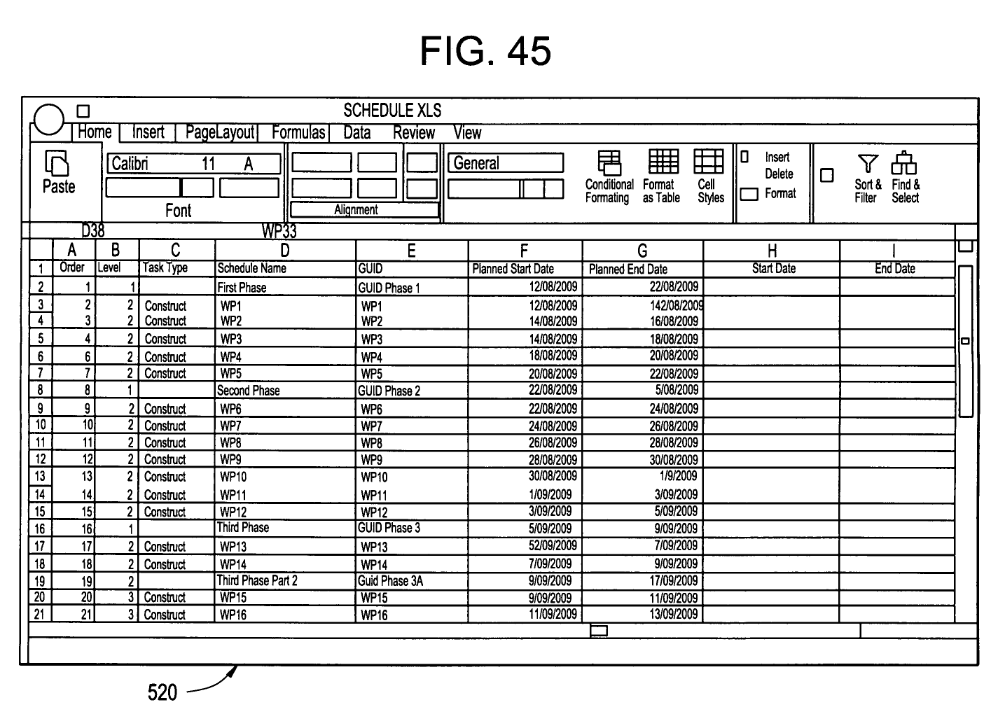

FIG. 45 depicts the contents of an Excel file that contains sample schedule data 520 that is used in the Scheduling Configuration.

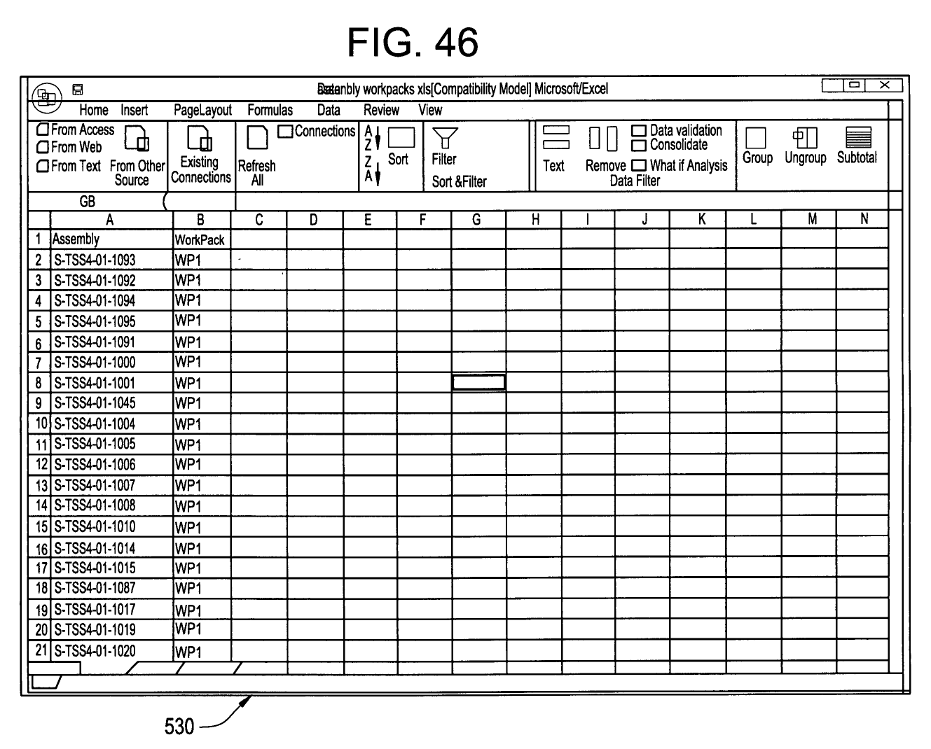

FIG. 46 depicts the contents of an Excel file that contains the model link data source mapping the assembly to workpack number.

### Scheduling Command

The Scheduling command configured in the Scheduling Configuration is executed by selecting the menu button bar 122 for the Scheduling menu 121 so that the Scheduling menu 121 expands as shown in FIG. 47. The appropriate Scheduling command button 124 in the Scheduling menu 121 is then clicked on. The model is then enumerated for objects that belong in workpacks for assigning to the Timeliner schedule.

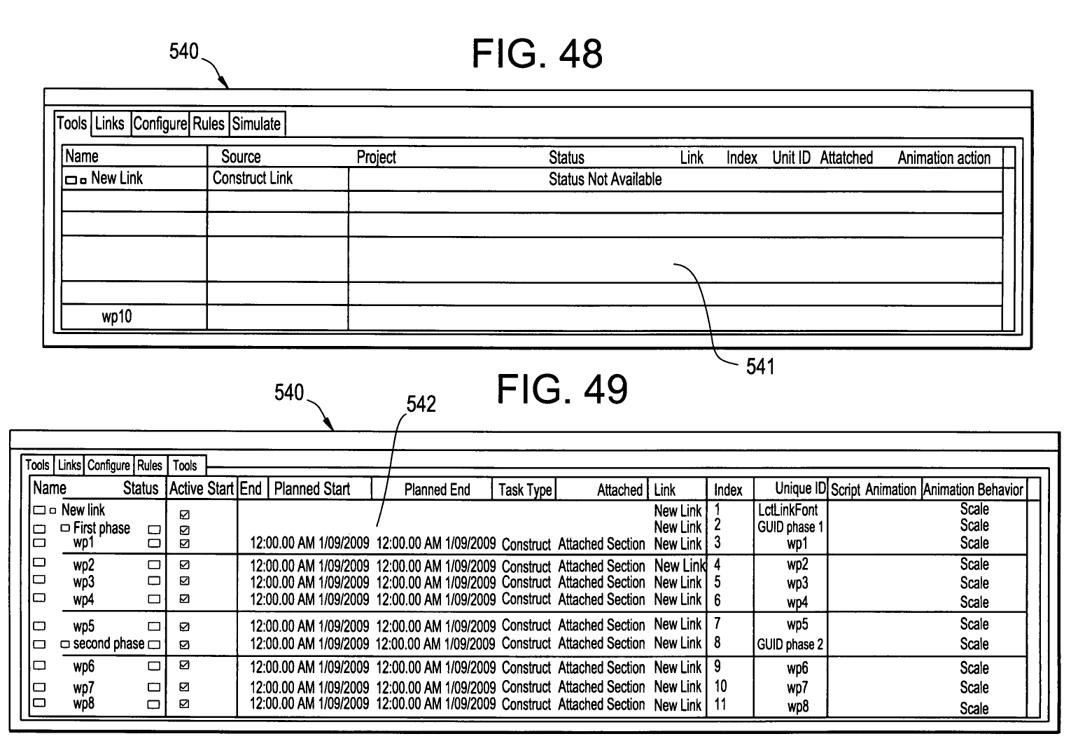

Referring to FIGS. 48 and 49, the plug-in application links the schedule data source to Timeliner. The establishment of the link is displayed in a Timeliner panel 540 in a Links tabbed box 541. The plug-in application loads the schedule data from the data source into the Timeliner panel 540. The information that can be brought in using the Navisworks® API is the Name, Start & End, Planned Start & End, Index and GUID fields.

The plug-in application then uses low-level coding to attach directly to the Timeliner panel's 540 control handle, select items in the model and then by sending low-level messages directly into a Tasks listbox 542, assigns the selection and the task type. This is not presently supported in the Timeliner API and is the major advantage of the plug-in application.

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

Throughout the specification and claims, unless the context requires otherwise, the term “substantially” or “about” will be understood to not be limited to the value for the range qualified by the terms.

It will be appreciated by those skilled in the art that variations and modifications to the invention described herein will be apparent without departing from the spirit and scope thereof. The variations and modifications as would be apparent to persons skilled in the art are deemed to fall within the broad scope and ambit of the invention as herein set forth.

1. A method of displaying one or more properties of a computerised model of an object, the method comprising the steps of:
creating a template for mapping the one or more properties to one or more standard properties;
selecting an item or group of the model, wherein the item or group includes the one or more properties;
mapping the one or more properties of the selected item or group to the one or more standard properties in accordance with the template; and
displaying the standard properties.

2. The method of claim 1, wherein the creating step comprises the steps of:
selecting a sample item or group of the model, wherein the sample item or group includes the one or more properties; and
collecting the one or more properties of the selected sample item or group.

3. The method of claim 2, wherein the creating step also comprises the step of selecting from the properties of the selected sample item or group.

4. The method of claim 2, wherein the creating step also comprises the step of entering a name for the one or more standard properties.

5. The method of claim 2, wherein the creating step also comprises the step of selecting an attribute from which the one or more properties are taken.

6. The method of claim 2, wherein the creating step also comprises the step of selecting an option to conduct a cyclic redundancy check (CRC) of the one or more properties.

7. A computer-readable storage medium on which is stored instructions that, when executed by a computer, cause the computer to perform the method of claim 1.

8. A computer programmed to carry out the method of claim 1.
